(19) United States
(12) Patent Application Publication
(10) Pub. No.: US 2024/0346581 A1
(43) Pub. Date: Oct. 17, 2024

(54) INCREMENTALLY PERFECTED DIGITAL ASSET COLLATERAL WALLET

(71) Applicant: SALT BLOCKCHAIN INC., Denver, CO (US)

(72) Inventors: Matthew Hill, Centennial, CO (US); Gregory Lloyd Bell, Denver, CO (US); Shawn Owen, Westminster, CO (US)

(21) Appl. No.: 18/507,422

(22) Filed: Nov. 13, 2023

Related U.S. Application Data
(63) Continuation of application No. 17/707,627, filed on Mar. 29, 2022, now abandoned.
Application No. 17/707,627 is a continuation of application No. 16/198,865, filed on Nov. 22, 2018, now abandoned.
(60) Provisional application No. 62/589,942, filed on Nov. 22, 2017.

(51) Int. Cl. G06Q 40/03; G06Q 20/10; G06Q 20/36; G06Q 20/38; G06Q 20/40

(52) U.S. Cl. CPC G06Q 40/03; G06Q 20/102; G06Q 20/36; G06Q 20/3825; G06Q 20/405

(57) ABSTRACT

A multisig digital asset wallet stores collateral for a loan between a borrower and a lender. The borrower and lender agree to loan terms including collateralization requirements. Over the course of the loan repayment period, a Loan-to-Value (LTV) ratio between the digital asset collateral and the loan principal balance will change due to fluctuations in the market exchange value of the digital asset and a declining loan principal balance due to regular loan repayments by the borrower. If the LTV exceeds the collateral requirements by an overage amount, then the borrower may sign a transaction and request signatures from other participants to withdraw funds from the multisig collateral wallet. If the LTV fails to satisfy the collateral requirements, participants may spend funds from the multisig collateral wallet to improve the LTV, catch up after a missed payment by the borrower, or pay down the loan principal.

### CROSS-REFERENCE TO RELATED APPLICATION(S)

This application is a continuation of U.S. patent application Ser. No. 17/707,627, filed Mar. 29, 2022, titled “INCREMENTALLY PERFECTED DIGITAL ASSET COLLATERAL WALLET,” which is a continuation of U.S. patent application Ser. No. 16/198,865, filed Nov. 22, 2018, titled “INCREMENTALLY PERFECTED DIGITAL ASSET COLLATERAL WALLET,” which claims priority to and benefit of U.S. Provisional Application No. 62/589,942, filed Nov. 22, 2017, the disclosures of which are incorporated herein by reference in their entireties.

### BACKGROUND

Loans may be secured by capital put up as collateral by a borrower according to a loan agreement with a lender. If minimum collateral conditions of the loan agreement are not met, a borrower may recapitalize the collateral, pay down the loan, or the lender may sell collateral. Management of the collateral presents difficulties due to need for monitoring constantly changing information including asset value and loan status, and difficulty transacting the collateral among trusted entities.

### SUMMARY

This summary is provided to introduce a selection of concepts in a simplified form that are further described in the Detailed Descriptions. This summary is not intended to identify key features or essential features of the claimed subject matter, nor is it intended to be used to limit the scope of the claimed subject matter.

### BRIEF DESCRIPTION OF THE DRAWINGS

FIG. 1 is a diagram of an example system for managing a loan collateralized by a digital asset collateral wallet.

FIG. 2 is a diagram of an example of generating multisig keys and a multisig collateral deposit address in a system for incrementally perfecting collateral in a digital asset collateral wallet.

FIG. 3 is a diagram of an example system including a loan manager in a system for incrementally perfecting collateral in a digital asset collateral wallet.

FIG. 4 is a time series diagram of incrementally withdrawing collateral from a digital asset collateral wallet.

FIG. 5 is a time series diagram of incrementally depositing into a collateral from a digital asset collateral wallet.

FIG. 6 is a time series diagram of liquidating collateral in a digital asset collateral wallet due to a missed regular payment by a borrower.

FIG. 7 is a diagram of an example system for managing a loan collateralized by one or more digital assets.

FIG. 8 is a signal diagram of an example system including a loan manager in a system for withdrawing collateral from a digital asset collateral wallet.

FIG. 9 is a plot of digital asset collateral value and loan principal against time for a loan case where digital asset collateral depreciates as market price falls and a borrower adds collateral to offset a deficiency in the collateralization parameters of the loan.

FIG. 10 is a plot of digital asset collateral value and loan principal against time for a loan case where a borrower withdraws digital assets from the digital asset collateral wallet twice in accordance with the collateralization parameters of the loan.

FIG. 11 is a plot of digital asset collateral value and loan principal against time for a loan case where a borrower misses a regular loan repayment on the loan, and digital asset collateral is liquidated to cover the missed repayment.

FIG. 12 is a plot of digital asset collateral value and loan principal against time for a loan case where a borrower cures a deficiency in the collateralization parameters of a loan by paying down additional principal.

FIG. 13 is a schematic diagram of a digital asset collateral wallet locked by encumbrance that depends on a locktime.

FIG. 14 illustrates an example locking script and example unlocking scripts for a digital asset collateral wallet with a multisig encumbrance.

FIG. 15 illustrates another example locking script and example unlocking scripts for a digital asset collateral wallet with a multisig encumbrance.

FIG. 16 illustrates another example locking script and example unlocking scripts for a digital asset collateral wallet with a multisig encumbrance.

FIG. 17 illustrates example operations for originating a loan with a digital asset collateral wallet.

FIG. 18 illustrates example operations for liquidating digital asset collateral to cure a loan-to-value (LTV) imbalance on a digital asset collateralized loan.

FIG. 19 illustrates an example system that may be helpful in using the digital asset collateral wallet.

FIG. 20 is an example time plot of a digital asset collateralized loan.

### DETAILED DESCRIPTION

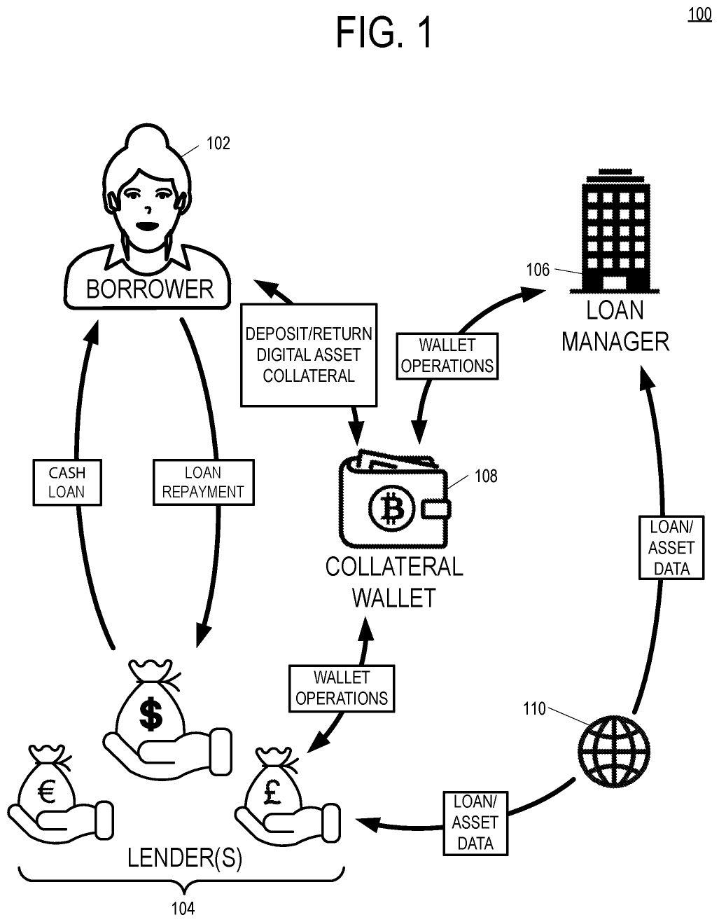

FIG. 1 is a diagram of an example system 100 for managing a loan collateralized by a digital asset collateral wallet 108. The digital asset collateral wallet 108 holds one or more digital assets as collateral on a loan between one or more lenders 104 and a borrower 102. The collateral wallet 108 may take various forms and/or combinations thereof: a single wallet (e.g., a deterministically created set of deposit addresses and private keys), a smart contract address of a dApp to which participants may send messages and data, a UTXO (unspent transaction output) with an encumbrance (e.g., an n-of-m multisig encumbrance), a single key wallet with a sharded private key, etc.

The system 100 includes various components for managing the digital asset collateralized loan including a loan manager 106 and a (direct or indirect) connection to a public network 110. In the system 100, loans may be made without resort to a credit rating system, which often inaccurately represents the credit worthiness of individuals and is rife with hazards relating to the privacy and identity security of participants, particularly of the borrowers. In the system 100, borrowers can participate in lending activities without revealing personal information about themselves to the lenders or to credit rating agencies that have a high potential for abuse. Due to the ease of use, security, liquidity, ease of transferability, ease of storability, ease of verification based on cryptographic proof, and other features of digital assets, lenders 104 can collateralize loans such that losses due to bad loans are reduced and profitability improved compared to a credit rating-based lending system. In some implementations, lenders 104 may choose to rely on a combination of credit scores on a borrower 102 from a credit rating agency in combination with digital asset collateral requirements of loan terms with the borrower 102.

The lender(s) 104 and the borrower 102 form a loan agreement for a loan (e.g., a cash loan) with loan agreement terms (e.g., interest rate, repayment schedule, collateralization rate, currency, etc.). The loan includes collateralization terms according to which a digital asset is held as collateral while the loan is outstanding. One type of loan collateralization term is collateral requirement parameters that set certain requirements that the digital assets comply with over the course of the loan repayment period. Collateral requirement parameters include, for example, without limitation, a collateralization rate, a minimum collateralization level, a target Loan-to-Value ratio (LTV), an initial LTV, a margin call LTV, a liquidation LTV, etc. The terms may include an LTV schedule identifying minimum LTVs for triggering an action over the course of the loan. Triggered actions may include: alerts to the borrower, margin call warnings, liquidations of collateral, etc.

The minimum LTV schedule may depend on other factors as well. Different digital assets are likely to have properties that differ from one another and have an impact on ability to convert to cash in the event of a liquidation. Some digital assets will be harder to liquidate than others. Lenders 104 may require higher LTV ratios be maintained for loans collateralized by harder to liquidate digital assets. Relevant factors to quality for a digital asset for liquidation purposes include, without limitation, global trading volume, trading volume against the currency in which the loan is denominated, depth of order books, estimated slippage, over-the-counter (OTC) trading availability, etc.

There could also be relevant factors to an LTV schedule specific to a loan manager 106. Depending on the configuration, moving digital assets out of the collateral wallet 108 may be cumbersome and time-consuming (e.g., when signatures from multiple participants are required). Depending on congestion on the network of the digital asset, confirmation of the transaction spending from the collateral wallet 108, to an exchange where it can be sold for another currency, could take an extended period of time. If a transaction attempting to spend from the collateral wallet 108 includes a transaction fee that is too low, then the transaction could become “stuck” and potentially even dropped from the mempool of pending transactions by nodes on the network of the digital asset. In an environment of rapidly decreasing prices, the loan manager 106 may choose to liquidate quickly to obtain a better price compared to waiting for a transaction to confirm from the collateral wallet 108. To facilitate quicker sales, the loan manager 106 may leave digital assets of the same type as held in the collateral wallet 108 on deposit at digital asset exchanges. The digital asset can thus be liquidated out of an account of a loan manager 106, then the spend from the collateral wallet 108 can reimburse the loan manager 106. If a loan manager liquidates digital assets in its accounts on exchanges and is waiting to be reimbursed, then the balances of the loan manager 106 on the exchanges may be reduced, potentially to zero. If a loan manager 106 is thus experiencing tight liquidity of its own, then minimum LTV values on the LTV schedule may be variable and dependent, at least in part, on the loan manager's liquidity on exchanges in the type of digital asset(s) to be held in the collateral wallet 108.

Another type of collateralization term includes various parameters that govern how the digital asset collateral is held, appraised, and/or analyzed during the course of a loan repayment period (e.g., a formula for determining prices of digital assets, a formula for determining liquidity of digital assets, etc.). The borrower 102 and the lender 104 may make aspects of the loan agreement terms and/or loan payment and repayment activity available to other parts of the system 100 for managing the digital asset collateral as described herein (e.g., the loan manager 106, each other, the public communications network, etc.).

Digital asset collateral includes digital assets that may be transferred between parties and monitored as described herein (e.g., cryptocurrencies, tokens transferable on a blockchain network according to smart contract rules, entries on a distributed ledger for which a party holds a private key, etc.). In one implementation, the digital asset collateral is stored in a collateral wallet 108. The digital asset collateral wallet 108 may be monitored by the participants in the system 100 (e.g., by exploring a copy of a public blockchain, by gaining access to a permissioned ledger, etc.). The digital asset collateral wallet 108 may include a wallet address (e.g., a public cryptographic key) to which funds may be sent on a blockchain network by broadcasting a transaction to participants of the blockchain network (e.g., to network nodes). In some implementations, the digital asset collateral wallet 108 is a multisignature (multisig) wallet for which various participants in the system 100 hold a single private key, and spending funds from the digital asset collateral wallet 108 requires a minimum number of private keys to sign a transaction (e.g., 3-of-4 multisig, 2-of-3 multisig, etc.).

In describing the digital asset collateral wallet throughout this disclosure, reference may be made to a 2-of-3 multisig encumbrance on the wallet. This disclosure should be understood to encompass other multisig encumbrances depending on the number of participants in implementations of the system. For example, a system including an arbiter may rely on a 3-of-4 multisig encumbrance but a 2-of-3 multisig encumbrance if an arbiter, in an implementation, is not present. Other potential designs of the collateral wallet 108 include: a single wallet (e.g., a deterministically created set of deposit addresses and private keys), a smart contract address of a dApp to which participants may send messages and data, a UTXO (unspent transaction output) with an encumbrance (e.g., an n-of-m multisig encumbrance), a single key wallet with sharded private key, etc. The collateral wallet 108 may be a collection of wallets of different digital assets to form a collateral basket of digital assets. In the case of multi-asset collateral, the individual assets may include their own LTV schedules and there may be a composed or weighted LTV schedule for the basket as a whole (e.g., 50% of the basket is bitcoin which is assigned a weight of 1.0; 30% of the basket is Ether which is assigned a weight of 0.7; and 20% of the basket is Dogecoin which is assigned a weight of 0.5). Weighting a component of the basket under 1.0, in this example, has an inverse relationship to the minimum LTV to trigger an action on the LTV schedule.

If the encumbrance on the multisig wallet(s) is a single signing key, then the loan manager may choose to keep the private keys offline and sign a transaction offline when a transaction is desired. This operation could be done unilaterally by the loan manager if the loan manager is entrusted to do so by the other participants.

The lender(s) 104 and the borrower 102 may agree on loan terms by communicating directly or via a lending marketplace. At a lending marketplace, lenders may advertise loan terms to borrowers who may choose to apply for a loan. A loan application may include demonstration of possession of digital asset collateral funds (e.g., cryptographically signing a message with a private key to prove ownership of an amount of digital assets). In some implementations, loan applications may include information needed to obtain a credit rating of the borrower 102 from a credit rating agency, and/or other information relating to the borrower's financial status (bank statement, deed of ownership, etc.). Lenders may offer loans of national fiat currencies issued by nations or states (e.g., U.S. Dollar, Euro, Japanese Yen, etc.), promissory notes for financial products, and/or other digital assets.

In some implementations, a loan manager 106 performs operations of the system 100. A loan manager 106 may, for example, operate a loan marketplace at which lenders 104 may advertise loans to potential borrowers 102 and borrowers 102 may provide information relating to identity, ability to pay, proof of digital asset reserves, etc. Before origination of a loan from the lenders 104 to the borrower 102, the loan agreement terms may include a collateral amount of a digital asset deposited in the collateral wallet 108. Depending on the loan agreement terms. The amount of digital assets to be deposited in the collateral wallet 108 may be based on a percentage of the cash loan.

Once the digital asset collateral has been deposited in the wallet 108, the participants of the system 100 may request or undertake wallet operations to add to/spend from the wallet over the course of the loan. Depending on the implementation, spending from the collateral wallet may be undertaken unilaterally (e.g., by the loan manager 106) or it may require agreement from more than one participant (e.g., an oracle, borrower, and/or lender cryptographically signs a blockchain transaction).

There are many distinct scenarios describing how digital asset collateral in the collateral wallet 108 may be spent or added to over the course of the loan. In one scenario, the collateralization requirements of the loan require a minimum LTV. If the value of the digital assets in the collateral wallet 108 increase in value as the loan principal decreases due to regular borrower payments over time, then the LTV of the loan will improve. The difference between the actual LTV and a minimum LTV may be termed a collateral overage amount. Depending on the collateral requirement terms of the loan, the lenders 104 and the borrower 102 may agree that the borrower 102 may withdraw some or all of the collateral overage amount. In other scenarios, an LTV of the loan may fall below a minimum amount, and the borrower 102 may choose to recollateralize the loan by sending additional digital assets to the collateral wallet 108. If a borrower does not send additional digital assets to recollateralize the loan, other participants in the system 100 may agree to spend some or all of the digital assets in the collateral wallet 108 to improve the LTV.

In other scenarios, the borrower 102 misses one or more regular payments on the loan, and other network participants of the system 100 may spend a portion of the digital assets in the collateral wallet 108 to cover some, all, or all plus more of the scheduled regular payment on the loan. Other scenarios also exist for movement of digital funds into or out of the collateral wallet 108 over the course of the loan because the rules governing collateral wallet operations depends on the collateral requirement parameters agreed to by the borrower 102 and the lenders 104.

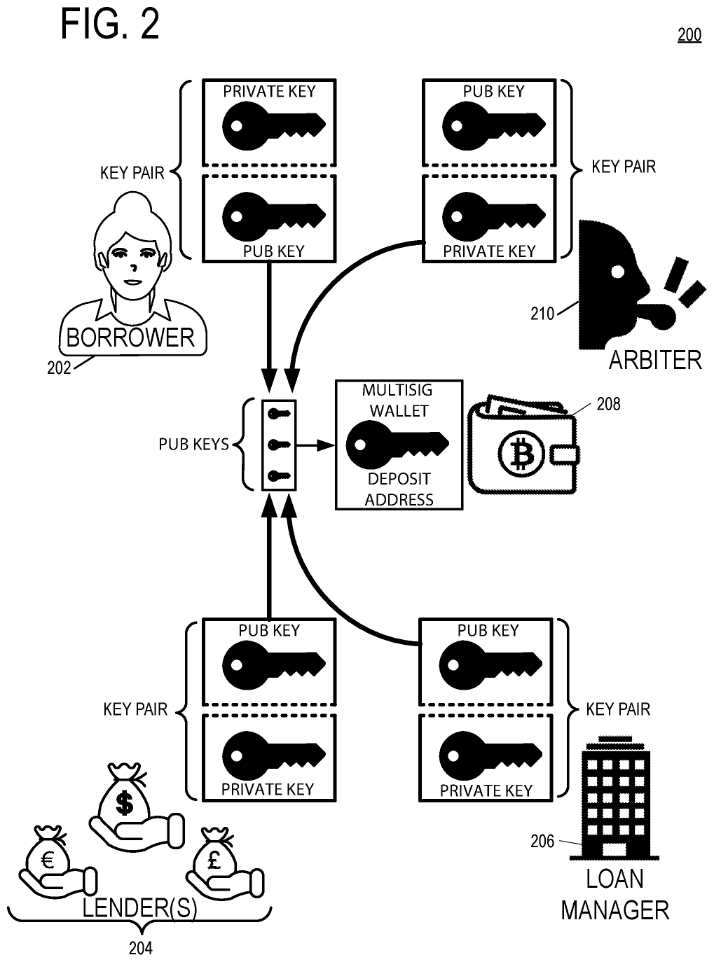

FIG. 2 is a diagram of an example system 200 for generating multisig keys in a system for incremental perfection of collateral in a digital asset collateral wallet 208. In the example illustrated in FIG. 2, there are three parties in the system 200: the borrower 202, the lenders 204, and a loan manager 206. Each of these three parties generates a public/private key pair in a secret process. The parties will generate unique public and private keys if they can produce a sufficient amount of entropy in the key generation process. The private keys are therefore known only to the respective entities that created them. The public keys may be shared with other participants, such as by publication and/or direct communication.

After the parties in the system 200 have generated their keys, a multisig public key can be generated from the three public keys generated by the participants. Each party may communicate the party's public key to any or all of the other parties in the system 200 until at least one party has all three public keys. The three public keys are inputs to create the multisig address that will serve as the digital asset collateral wallet 208. The multisig address of the wallet 208 is also termed herein the multisig wallet deposit address. A participant that calculates the multisig wallet deposit address may communicate the address to the other parties. Alternatively, or additionally, each party may calculate the public multisig key address independently if the party has received the public keys of each of the other parties in the system 200.

The borrower 202 broadcasts a transaction to the multisig wallet deposit address on a blockchain network to transfer the digital asset collateral to the wallet 208. If the blockchain is a public blockchain, or if the parties in the system 200 have permissioned access to the blockchain, they can verify that the digital asset collateral has been deposited in the wallet 208 by checking a copy of the shared ledger after the borrower's transaction has been confirmed according to the consensus rules of the blockchain. Parties can verify collateral wallet 208 contents by maintaining their own copy of the shared ledger, by requesting the balance of the wallet 208 from another blockchain network node, etc.

In the example illustrated in FIG. 2, the digital asset collateral wallet 208 is a 2-of-3 multisig wallet. A 2-of-3 multisig means that a minimum of two of the three private keys must sign a transaction to successfully move funds out of the collateral wallet 208. Participants in the system 200 may sign a transaction and transmit the signed transaction to other participants, who can also sign the transaction. Once at least two of the participants have signed the transaction with their respective private keys, then the transaction may be broadcast to the blockchain network to move funds out of the collateral wallet 208.

If repayment of a loan is complete, the digital asset collateral is released back to the borrower under the terms of the loan agreement by broadcasting a signed transaction to the blockchain network to transfer the digital asset collateral from the collateral wallet 208 to a wallet address controlled by the borrower 202 (e.g., to a non-multisig wallet address for which the borrower 202 holds the private key). In this example, the borrower 202 may initiate a request to other private key holders (e.g., a sufficient number of multisig private key holders to unlock the multisig wallet) to sign a transaction to refund the digital asset collateral at the conclusion of the loan repayment period. The borrower 202 may herself formulate and output the withdrawal transaction and request that other signers sign the withdrawal transaction. In other implementations, other participants may formulate and output the withdrawal transaction and sign without input from the borrower 202 since transactions spending from the multisig wallet need not include signatures from every private key holder. In some implementations, the request of the borrower 202 to sign a withdrawal transaction includes a payment address controlled by the borrower (e.g., a public address to which the borrower 202 owns a private key).

Digital asset collateral may be moved from the collateral asset wallet 208 for other reasons as well. Depending on the digital asset collateral requirements, the borrower 202 may be responsible for maintaining a minimum digital asset collateral value or responsible not to exceed a maximum LTV on the loan. If the LTV of the loan, on the other hand, is not near a maximum LTV, then the terms of the loan agreement may allow the borrower 202 to withdraw some of the digital asset collateral from the wallet 208 to her own wallet. If the value of the digital asset collateral increases over a period of time during which the borrower 202 has paid down a principal balance on the loan, then the LTV may improve to the point where it substantially exceeds the minimum LTV under the terms of the loan agreement. In such a case, the borrower 202 may request that the other participants in the loan system 200 sign a transaction moving some of the digital asset collateral to another wallet owned by the borrower 202.

Another reason the digital asset collateral may be moved from the collateral wallet 208 is if the LTV exceeds a level determined by the loan agreement or if the borrower misses one or more repayments on the loan and the loan is no longer in good standing. The terms of the loan agreement may provide for liquidation of some or all of the digital asset collateral if the LTV exceeds an agreed limit or if a number of repayments are missed by the borrower. Some or all of the digital assets stored on the collateral wallet 208 may be moved to a digital asset exchange where they may be sold for another type of currency or another digital asset (e.g., the digital assets may be sold for the currency that was loaned to the borrower 202 under the terms of the loan agreement).

The borrower 202 may refuse to sign a transaction with the borrower's private key to the digital asset collateral wallet 208 if the funds are to be liquidated. Since, in the example illustrated in FIG. 2, the digital asset collateral wallet 208 is a 2-of-3 multisig wallet, the other three participants in the system 200 must sign a transaction with their respective private keys to move digital asset collateral out of the wallet 208. The loan manager 206, for example, may have access to the status of the loan between the lenders 204 and the borrower 202 and is therefore able to determine when the loan is not in good standing. In another implementation, the loan manager 206 receives a copy of the loan repayment schedule and the loan agreement terms relating to minimum collateralization, maximum LTV and/or other parameters of the loan relating to the collateral. In some implementations, the loan agreement terms and the collateral requirement parameters are stored on a blockchain, such as in a smart contract. Due to the immutable characteristics of blockchains, the participants may choose to rely on the loan terms in the chain as proof of the authenticity of the terms. The loan manager 206 may independently and/or cooperatively receive one or more price feeds of the digital assets in the collateral wallet 208 to determine whether the terms of the loan agreement permit moving digital asset capital out of the wallet 208.

The loan manager 206 may further determine which addresses are appropriate to receive any funds moved from the collateral wallet 208. For example, if a maximum LTV is breached under the terms of the loan agreement due to falling digital asset collateral prices, then the terms of the loan agreement may permit funds to be moved to a digital asset exchange for liquidation. The digital asset exchange may be an approved destination for funds under the loan agreement, and the loan manager 206 may choose to sign a transaction with their private keys moving digital asset collateral from the wallet 208 to a wallet controlled by the digital asset exchange and under the control of one of the participants in the system 200.

The system 200 may further include an arbiter 210. The arbiter 210 may be a trusted third party (e.g., a bank, an arbiter service), an autonomous organization (e.g., consensus code on a blockchain), an operation of another participant (e.g., the loan manager), etc. The arbiter 210 may participate in the system by deciding whether conditions relating to the loan and/or the digital asset collateral wallet have been met. For example, the arbiter 210 may decide that a clause of the loan agreement should be triggered (e.g., a force majeure clause, a terminal clause, etc.) or whether a real-world event has occurred. The arbiter may condition actions relating to the digital asset collateral wallet 208 on its decisions. Alternatively, or additionally, the arbiter 210 may supply its decisions to other participants (e.g., notifying the loan manager 206 that a clause in the loan agreement has been triggered).

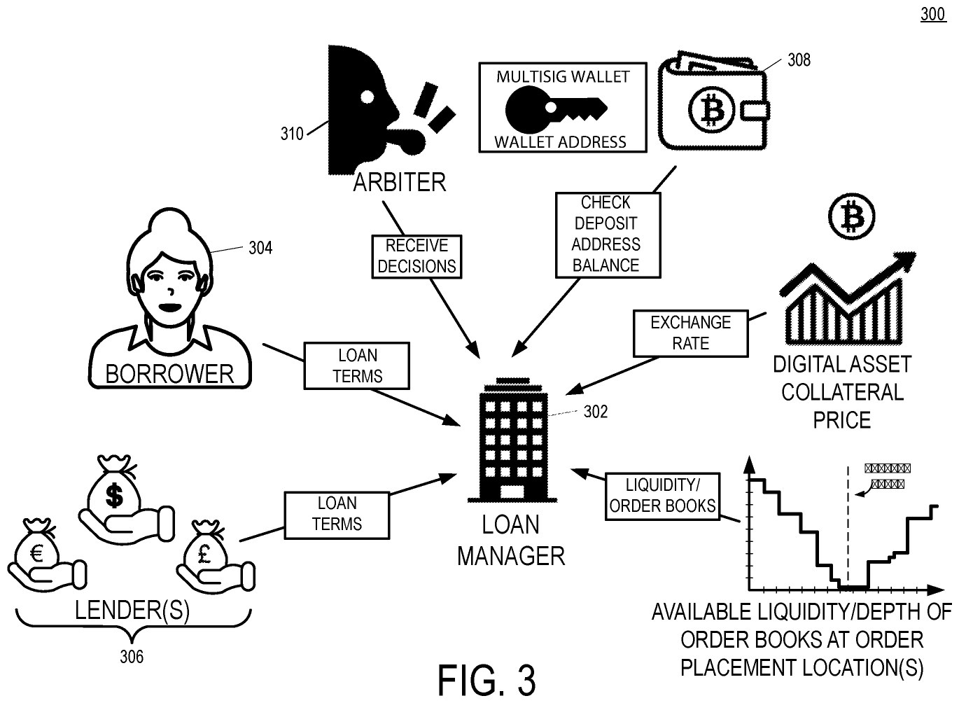

FIG. 3 is a diagram of an example system 300 including a loan manager 302 for managing incrementally perfected collateral in a digital asset collateral wallet 308. The loan manager 302 may receive information from a variety of sources to perform the steps described herein including determining whether the digital asset collateral value satisfies collateral requirement parameters and whether funds should be moved in to/out of the collateral wallet 308.

One type of information received by the loan manager 302 is an agreed loan schedule and/or loan terms from a borrower 304 and/or a lender 306. The loan manager 302 may receive the loan schedule and terms directly from the contracting parties or the loan schedule and terms may be stored in a blockchain by the borrower 304 and lender 306 such that the loan manager 302 may retrieve the loan schedule and terms directly from the blockchain. In one implementation, a smart contract on the blockchain accepts loan terms from the lender 306 and borrower 304 based on a signed message from those participants. For example, a message signed by the owner of a public address that funded the digital asset collateral wallet 308 can be taken as cryptographic proof of the identity of the borrower 304 when submitting an agreed loan schedule, LTV schedule, and/or terms. The LTV schedule may define trigger LTV levels such as an LTV that will trigger alerts to the borrower/lender, margin calls, liquidations, etc. The LTV schedule may depend on the type(s) of digital assets in the collateral wallet and on other factors such as trust in the digital asset (e.g., bitcoin is more trusted to the lender(s) than Dentacoin).

Another type of information collected by the loan manager 302 is the current status of the loan between the lenders 306 and the borrower 304 to determine whether the loan complies with the loan terms at various points of time over the course of the loan. The lender 306 and/or borrower 304 may transmit updates to the loan manager 302 over the course of a loan to demonstrate the state of the loan (e.g., when a borrower makes loan repayments, the borrower may transmit proof of payment to the loan manager 302). In other implementations, a banking institution may provide a feed to the loan manager 302 regarding the status of the loan and a history of origination and repayments on the loan.

Another source of information that can be received by the loan manager 302 is from the digital asset collateral wallet 308 itself (e.g., by checking a copy of the shared ledger on which the wallet 308 resides, requesting a network node to transmit the quantity of digital assets in the wallet 308, etc.). Another source of information that can be received by the loan manager 302 is a price of the digital assets held as collateral on the loan. The loan manager 302 may receive price information from a variety of exchange locations where trades are occurring between the type of digital asset held as collateral and other currencies or digital assets. Market trades usually occur at a regular basis on exchanges that support trading of digital assets. A market trade price feed may be received by the loan manager 302 at regular intervals such that the loan manager 302 can calculate a value of the collateral wallet in terms of a different currency (e.g., the currency of the loan between the lender and the borrower).

In some implementations, digital asset price information may be processed by another party (e.g., the loan manager) before feeding the price information to the loan manager 302. For example, a loan manager 302 may apply a volume-weighted average to a price of a digital asset as trades across each of a group of digital asset exchanges. Alternatively, or additionally, the loan manager may exclude trading prices from exchanges that have low volume or low liquidity. In other implementations, a price feed may be received by the loan manager 302 by an over-the-counter (OTC) counterparty. The price feed received by an OTC counterparty may include a time window during which an offer to buy up to a maximum amount of the digital asset is valid.

Another source of information that can be received by the loan manager 302 is the available liquidity and depth of order books at order placement locations. Order placement locations are locations where the digital asset collateral could be sold for another currency or digital asset in the event that such a sale is permitted under the terms of a loan agreement between the borrower 304 and lender 306.

In implementations, the loan manager 302 may receive decisions from an arbiter 310. The arbiter 310 may be a trusted third party (e.g., a bank, an arbiter service), an autonomous organization (e.g., consensus code on a blockchain), an operation of another participant (e.g., the loan manager), etc. The arbiter 310 may inform the loan manager whether conditions relating to the loan and/or the digital asset collateral wallet have been met. For example, the arbiter 310 may decide that a clause of the loan agreement should be triggered (e.g., a force majeure clause, a terminal clause, etc.) or whether a real-world event has occurred.

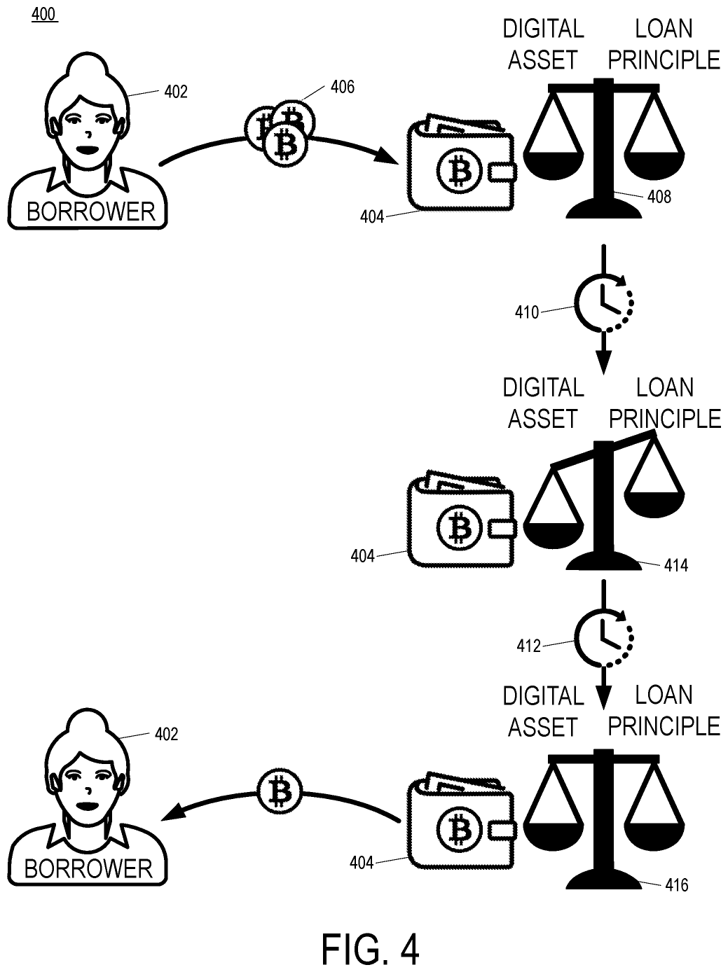

FIG. 4 is a time series diagram 400 of incrementally withdrawing collateral from a digital asset collateral wallet 404. In the example illustrated in FIG. 4, a borrower 402 spends digital asset collateral 406 to a multisig wallet 404. The amount of the digital asset collateral 406 results in an LTV 408 of the loan collateralized by the digital assets in the digital asset collateral wallet 404. The LTV 408 may satisfy digital asset collateral requirements agreed to as an initial collateralization rate between the borrower 402 and the lender at the beginning of a loan period. After a time period 410 has lapsed, the market exchange value of the digital assets in the collateral wallet 404 has increased, resulting in the LTV that is weighted more towards the digital asset than the loan principal compared to the LTV at the beginning of the loan period. If the LTV 414 exceeds a minimum LTV ratio as agreed to by the lender and the borrower 402, then the borrower may withdraw a collateral overage amount from the digital asset collateral wallet in accordance with the digital asset collateral requirements of the loan agreement. After a time period 412, a transaction has been broadcast to the blockchain network on which the digital asset collateral wallet 404 resides spending a collateral overage amount from the digital asset collateral wallet 404 to a wallet address controlled by the borrower 402.

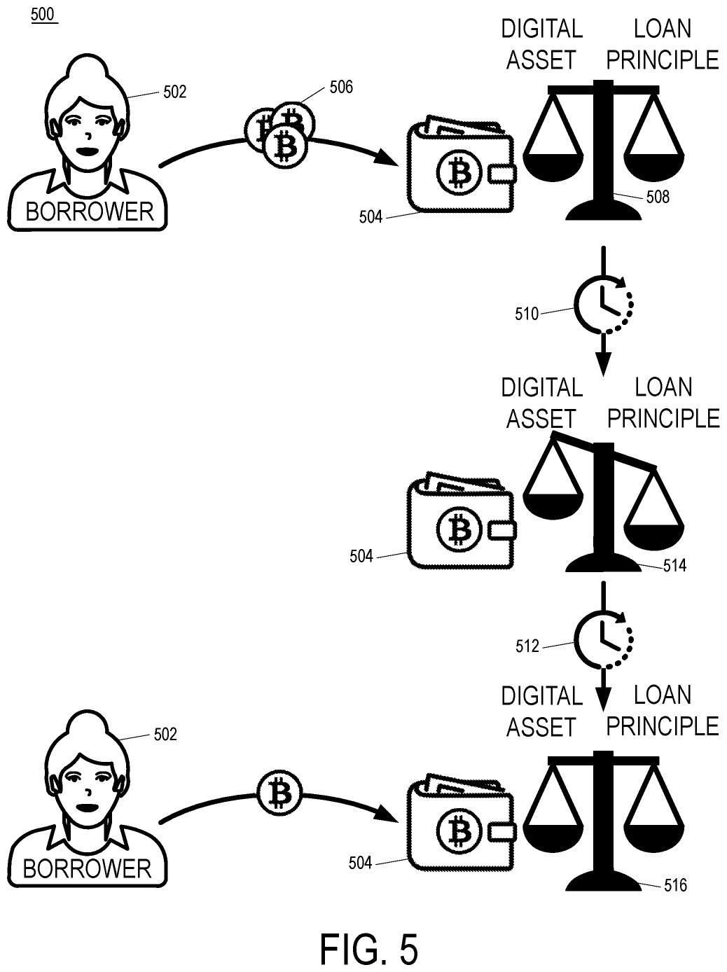

FIG. 5 is a time series diagram 500 of incrementally adding digital asset collateral to a digital asset collateral wallet 504. In the example illustrated in FIG. 5, a borrower 502 spends digital asset collateral 506 to a multisig wallet 504. The amount of the digital asset collateral 506 results in an LTV 508 of the loan collateralized by the digital assets in the digital asset collateral wallet 504. The LTV 508 may satisfy digital asset collateral requirements agreed to as an initial collateralization rate between the borrower and the lender at the beginning of a loan period. After a time period 510 has lapsed, the market exchange value of the digital assets in the collateral wallet 504 has decreased, resulting in the LTV that is weighted more towards the loan principal than the digital asset collateral compared to the LTV at the beginning of the loan period. If the LTV 514 fails to exceed a minimum LTV ratio as agreed to by the lender and the borrower 502, then the borrower may add a collateral catch-up amount to the digital asset collateral wallet in accordance with the digital asset collateral requirements of the loan agreement. After a time period 512, a transaction has been broadcast to the blockchain network (e.g., in response to a margin call warning received by the borrower 502) on which the digital asset collateral wallet 504 resides spending a collateral catch-up amount from a wallet address controlled by the borrower 502 to the digital asset collateral wallet 504 to cure the LTV deficiency caused by declining digital asset values.

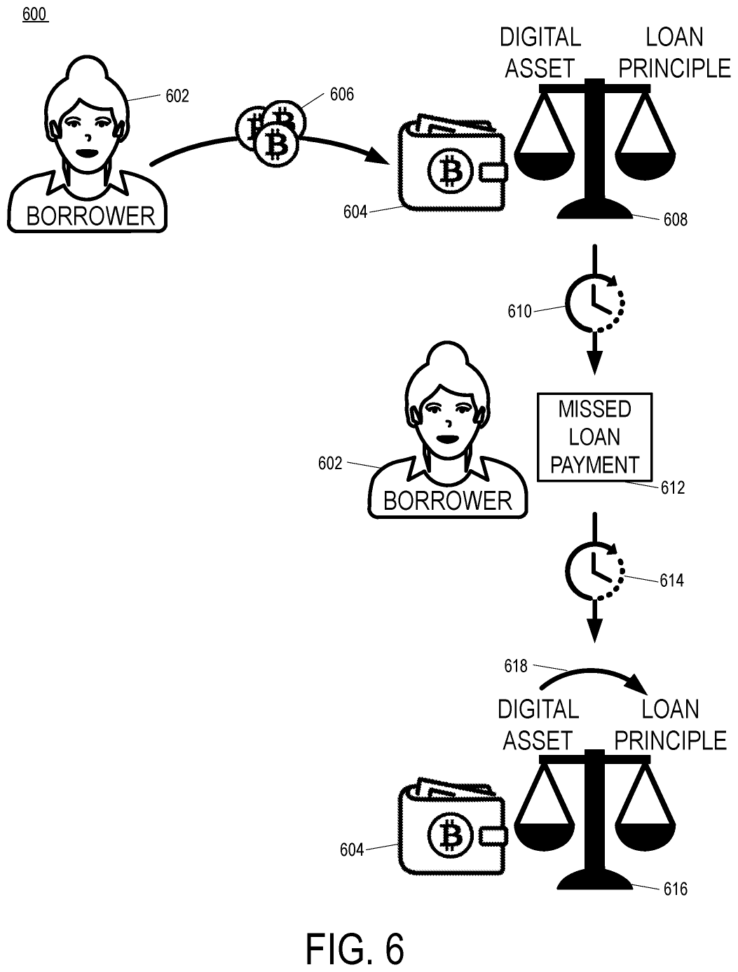

FIG. 6 is a time series diagram 600 of liquidating collateral in a digital asset collateral wallet 604 due to a missed regular payment by a borrower 602. In the example illustrated in FIG. 6, a borrower 602 spends digital asset collateral 606 to a multisig wallet 604. The amount of the digital asset collateral 606 results in an LTV 608 of the loan collateralized by the digital assets in the digital asset collateral wallet 604. The LTV 608 may satisfy digital asset collateral requirements agreed to as an initial collateralization rate between the borrower and the lender at the beginning of a loan period. After a time period 610 has lapsed, the borrower 602 misses a loan repayment according to the loan schedule. After a time period 614, a transaction has been broadcast to the blockchain network on which the digital asset collateral wallet 604 resides spending a regular payment amount from the digital asset collateral wallet 604 to a wallet address controlled by the lender to reduce the principal balance and bring the LTV 616 into compliance with the digital asset collateral requirements of the loan.

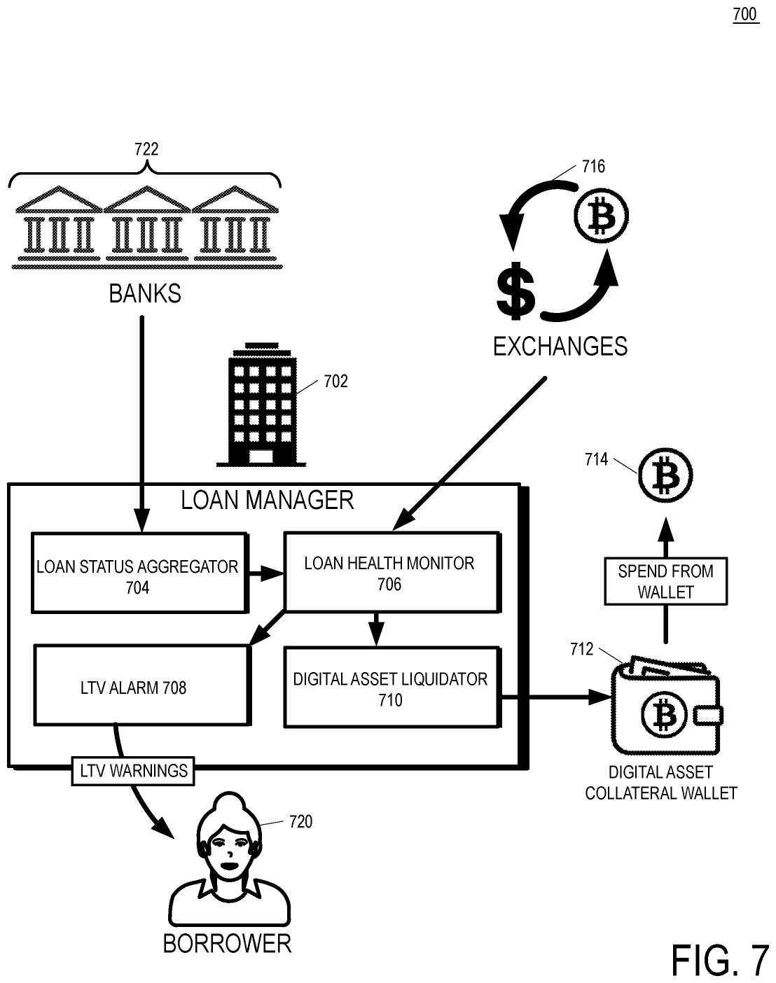

FIG. 7 is a diagram of an example system 700 with a loan manager 702 performing loan monitoring operations and wallet operations on a collateral wallet 712 containing digital asset collateral. The loan manager 702 includes several components for carrying out the functions described herein including the loan status aggregator 704, the loan health monitor 706, an LTV alarm 708, and a digital asset liquidator 710. The loan manager 702 may initiate a spending transaction from the digital asset collateral wallet.

In one implementation, the loan manager 702 initiates transactions from the collateral wallet 712 in the case that the value of the digital assets fall below a triggering LTV ratio compared to the balance of the loan or if the digital asset collateralization requirements are exceeded by an overage amount. The loan status aggregator 704 may perform functions that involve comparing loan agreement terms to data obtained from other sources (e.g., off-chain loan contact received from the borrower and/or lender, checking loan terms that have been stored on-chain, digital asset price feeds, digital asset liquidity assessments, etc.) to determine whether collateralization requirements are met.

One of the components of the loan manager 702 is the loan health monitor 706 that determines a Loan-to-Value ratio (LTV) based on loan information, for example, based on periodic status updates of the loan received from the loan status aggregator 704. One way to determine an LTV is to receive a repayment status of the loan collateralized by the collateral wallet 712 including a remaining principal amount and compare the remaining principal amount to an equivalent value of the digital asset collateral on the wallet 712. Another way is to receive one or more LTV schedules regarding the loan, the LTV schedules having LTV levels that will trigger actions by the loan manager 702 (e.g., an overage LTV above which borrower 720 can withdraw overage collateral, an LTV to trigger an alarm, a liquidation LTV). An equivalent value of the digital asset collateral may include, for example, a value in U.S. Dollars. The value in U.S. Dollars may be calculated with information received by the loan health monitor 706 from digital asset exchanges 716, OTC participants, and/or other potential digital asset liquidation locations. The amount of digital assets in the wallet 712 may be determined by the loan health monitor 706 by checking a copy of the shared ledger on which the digital assets collateral wallet 712 resides.

The loan health monitor 706 also determines margin call and liquidation order triggers. Loan agreement terms and/or the LTV schedule may include a margin call condition (e.g., an LTV above which the margin call is triggered). If the loan manager 702 determines that a margin call condition has been satisfied, then the loan manager 702 may take actions to carry out the margin call.

If the trigger in the LTV schedule is a warning message, the loan health monitor 706 may command the LTV alarm 708 to communicate the alert (e.g., a low LTV alert to the borrower 720) or to a participant in the loan system (e.g., a loan officer, a lender, a bank, a party who has extended credit to the borrower, etc.). The warning communication may be an electronic communication including, without limitation, an email, an SMS message, a notification, etc. to the loan system participant. In some implementations, the loan manager 702 initiates the communication through contact with an API providing the communications service. In other implementations, another participant (e.g., an on-chain oracle, a lender, a borrower, etc.) transmits a request to the loan manager 702 to take action in response to the margin call condition satisfaction.

The warning communication from the LTV alarm 708 may include a stop loss price at which some or all of the digital assets in the wallet 712 will be liquidated if the margin call condition is not removed and a liquidation condition is satisfied. The warning communication may include instructions to the recipient (e.g., the borrower) for steps that would remove the margin call condition. For example, the warning communication may include an amount of additional digital asset capital that would need to be added to the collateral wallet 712 to lower the LTV to a point where the margin call condition would no longer be satisfied. If the borrower or another party makes a payment of digital asset capital to the wallet 712, then the loan manager 702 may send another message notifying that the margin call condition has been removed.

The digital asset liquidator may also determine whether the digital assets in the wallet 712 satisfy a liquidation condition. Satisfying a liquidation condition may include an LTV that is lower than the LTV that triggers the margin call condition. Upon satisfaction of a liquidation condition, the loan manager 702 may take any of several actions relating to liquidation of the digital assets in the collateral wallet 712. One action is to determine a stop loss price at which the digital assets will be sold at a liquidation location. The stop loss price may be related to a liquidation sell order size. It may not be necessary for the loan manager 702 to sell all of the digital assets in the wallet 702. Instead, only a fraction of the digital assets may be sold to lower an LTV of the loan until the liquidation condition is no longer satisfied.

Another action taken by the digital asset liquidator 710 in response to the satisfaction of a liquidation condition is to determine sell order placement location for the fraction of the digital assets in the wallet 712 to be liquidated. A determination of sell order placement may depend on various factors that affect the profitability to liquidation sales. Different liquidation locations 716 (e.g., digital asset exchanges, OTC participants, private parties, etc.) may charge different trading fees depending on a number of factors. Different liquidation locations 716 may have varying amounts of liquidity that will limit how many coins or tokens may be sold below a certain price. At liquidation locations 716 with thin liquidity, selling digital assets may move the price more than on liquidation locations 716 with larger liquidity. Other liquidation locations 706 may not offer liquidity information (e.g., over-the-counter trading locations, brokers of digital assets, etc.). For liquidation locations 716 that do not provide liquidity information, a sell quote may be obtained including a sales price for a certain amount of the digital asset to be liquidated.

Another factor bearing on the selection of liquidation locations 716 is an expected time delay between a decision by the digital asset liquidator 710 to liquidate a fraction of the digital assets held in the collateral wallet 712 and the time when the assets are actually sold. Various factors may introduce delay into the liquidation process that could have a material effect on the obtainable market exchange value of the digital assets, especially under conditions of rapidly falling price of the digital asset where liquidation conditions are more likely to be satisfied. In implementations wherein the collateral wallet 712 is a multisig wallet, any transaction spending from the wallet requires more than one signature by a private key holder. It may be expected that a borrower may not respond to a request to liquidate the borrower's assets, and thus a signature may be necessary from another key holder (e.g., the lender, an oracle, etc.). There could be delays in obtaining the needed signatures. For example, the lender may not be operating normally, such as outside of normal business hours. In the case wherein an oracle is requested to sign a transaction spending funds from the collateral wallet 712, network congestion on the oracle's blockchain network could cause a request transaction to the oracle to wait unconfirmed in a network mempool for an undue length of time, depending on the network usage and the characteristics of the spending transaction. Blockchain network congestion could also cause a delay in confirmation of the spending transaction.

Other factors relating to selection of liquidation locations 716 include counterparty risk associated with receipt of the digital assets to be spent at the liquidation location. For example, a digital asset exchange may delay in crediting the loan manager's account with digital asset funds sent to the exchange depending on the particular digital asset exchange's policies regarding crediting customer accounts. Even after a transaction sending digital assets to an exchange has been confirmed by the blockchain network on which the collateral wallet 712 resides, the exchange may not immediately credit the asset's to the loan manager's account. The price of the digital asset may continue to fall while the loan manager 702 is waiting for an account to be credited in this scenario. Accordingly, the loan manager 702 may “price in” continued market exchange rate deterioration between the times a liquidation decision is made and the liquidation sale is completed. Alternatively, or additionally, the loan manager 702 may choose liquidation locations 716 that offer frequently updated price feeds (e.g., OTC brokers). As yet another alternative, the loan manager 702 may choose to leave its own digital assets at liquidation locations 716 to facilitate faster liquidation sales, and any transaction spending digital assets from the collateral wallet 712 may be formed to reimburse the loan manager 702 with liquidated digital assets.

After the digital asset liquidator 710 has determined liquidation placement locations for liquidating digital assets in the collateral wallet 712 the fraction of the funds to be liquidated may be moved from the collateral wallet 712 to the liquidation locations 706. To accomplish the transfer, a transaction is formed that complies with the format and consensus rules of the blockchain on which the collateral wallet 712 resides. If the collateral wallet 712 is multiple wallets each holding a different digital asset, then there may be a separate transaction for up to all of a basket of digital assets that make up the collateral wallet 704. In one implementation, the collateral wallet 712 is a multisig wallet, such as a 2-of-3 multisig. As such, one participant in the system may create the transaction and sign the transaction with one of the private keys, if the entity is in possession of the one of the private keys. After the transaction has been created (and potentially also signed), the transaction can be circulated to the other loan participants that hold at least three of the four private keys needed to unlock the collateral wallet 712. In one implementation, the loan manager 702 creates and signs the transaction and then transmits the transaction to the loan manager and the lender (and additionally the borrower).

In the implementation of a multi-sig collateral wallet, once at least two of the three holders of private keys for the collateral wallet 712 have signed one or more transactions, those transactions may be broadcast to the blockchain on which the wallet 712 resides. When holders of private keys receive a transaction and a request to sign the transaction from another participant (e.g., the loan manager requests signature on a transaction the oracle created and signed), the holder of the private key can identify what would be the destination of the funds if the transaction were accepted by the blockchain network. What the holders of the private keys may not know is what real-world entity owns the address into which the funds would be deposited. The private key holders may further receive additional information from the loan manager 702 relating to the identity of the liquidation locations 716 and/or the liquidation strategy for placing sell orders after the funds have been deposited at the liquidation locations 716. The holders of the private keys may seek independent verification of the ownership of a payee address in a transaction requested to be signed by the loan manager 702. For example, liquidation locations 716 may be requested to sign a message with a private key that corresponds to the payee public key to prove that the liquidation location 716 actually controls the payee address.

After funds have been successfully moved out of the collateral wallet 712 and onto the liquidation locations 716, the loan manager 702 can submit sell orders at the liquidation locations 706 to convert the deposited digital assets into another currency. In some implementations, deposited digital assets are converted into the currency of the collateralized loan for application to the principal of a loan to reduce an LTV of the loan. The loan manager 702 may submit limit sell orders on the deposited digital assets in accordance with the sell order placement determined when the LTV satisfied the liquidation condition. The loan manager 702 may then submit a withdraw order at the liquidation locations 716 to withdraw the purchased currency (e.g., a bank wire withdrawal of U.S. Dollars to a bank account controlled by a lender).

Actions by components of the loan manager 702 with regard to one loan could have effects on other loans managed by the loan manager 702. For example, if the digital asset liquidator 710 maintains deposits on various exchanges 716 for purposes of immediate liquidation (e.g., to be reimbursed later from the digital asset collateral wallet 712), then the ability of the digital asset liquidator 710 to immediately liquidate decreases as the amount of digital assets on deposit at the exchanges 716 and/or with OTC traders decreases. To compensate, the digital asset liquidator 710 may communicate to the loan health monitor 706 current levels of deposited assets under control of the loan manager 702. If levels of deposited assets decline, then LTV schedules on loans under management by the loan manager 702 may be adjusted to reflect increased difficulty in liquidating by raising minimum LTV values while the low deposit conditions on the exchanges 716 persist.

Making such an adjustment to an LTV may be based on an expected realized value of the digital asset. As explained herein, the expected realized value may depend on various factors. Examples include: a confidence factor in the collateral digital asset(s) (e.g., bitcoin is more trusted than other coins), global trading volume, trading volume against the currency in which the loan is denominated, a liquidity of the loan manager 702 in terms of how much digital asset value is on deposit with an exchange compared to digital assets that would have to be spent from a collateral wallet before being spent, order book depths, order book distribution, etc.

In one example, the digital asset collateral wallet 712 is actually a collection of multiple collateral wallets, each wallet holding a different type of currency. Comparatively greater volume may make a digital asset more attractive as collateral because it can be more easily converted to another currency (e.g., U.S. Dollars) to cure a deficiency in a loan. Digital assets with comparatively less trading volume may be less attractive because prices are more likely to move faster with greater volatility, and attractive asks on order books may disappear more quickly if there are comparatively fewer of them. Accordingly, an LTV schedule may weight digital assets with different trading volume levels differently. One example of a weighting formula is to set a dominant digital currency trading volume (e.g., bitcoin) to 1.0 and adjust others accordingly:

$$Weight = \frac{{asset}^{′} s 24 hour volume}{{bitcoin}^{′} s 24 hour volume} * price * quantity of collateral$$

Other adjustments to calculate an expected realized value include adjustments based on a liquidity factor, trading volume, market capitalization (alone or in comparison to another coin), volatility, order book analysis, deposit exchange holdings, total amount of the digital asset collateralized by sellers (e.g., if a large percentage of all bitcoin in circulation were staked as collateral for loans, there could be a systemic risk to the system), a total market capitalization factor, a coin trust factor, etc.

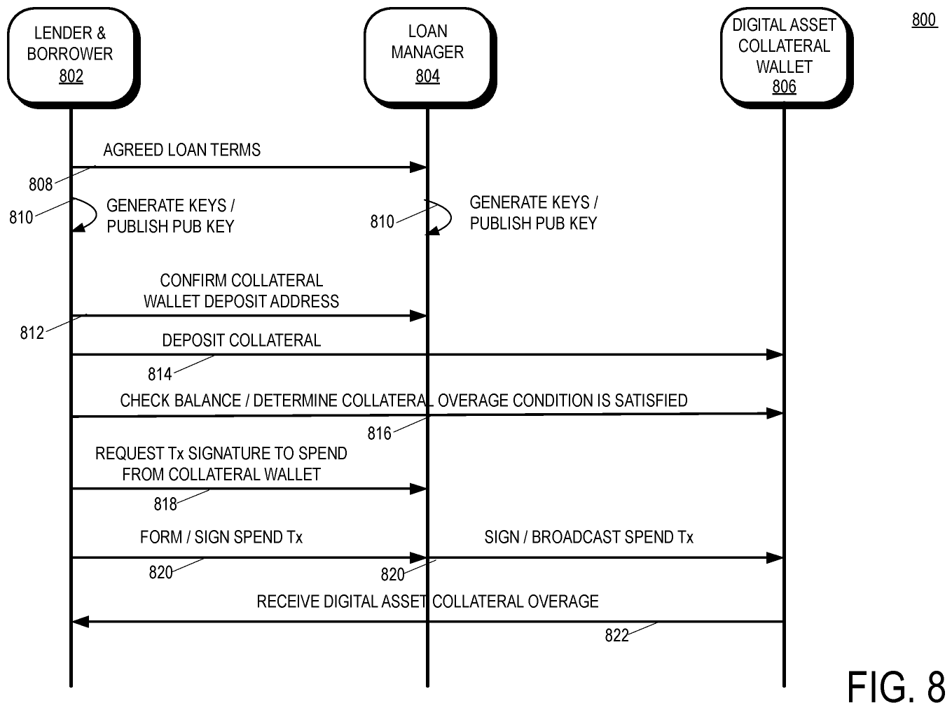

FIG. 8 is a signal diagram of an example system 800 with a lender and borrower 802 and a loan manager 804 performing loan monitoring operations and wallet operations on a digital asset wallet 806 containing digital asset collateral. At operation 808, a lender and borrower 802 send agreed loan terms to a loan manager 804. The terms may be sent directly to the loan manager 804, stored on an immutable blockchain where the loan manager 804 can access them by searching a copy of the shared ledger. When stored on a blockchain, the loan terms may include digital signatures to prove identity of the lender and borrower 802. The loan terms may include information relevant to the management of the digital asset wallet 806 (e.g., the identities of the various participants in the loan network, payment addresses for participants including digital asset payment addresses and/or fiat currency bank account addresses, loan terms, loan schedule, permissions to monitor loan origination and/or repayments over the course of the loan, etc.).

At operation 810, all parties generate a public/private key pair. Optionally, operation 810 publishes a public key for other loan network participants to read. Alternatively, or additionally, operation 810 includes transmitting the public key to other loan network participants directly or indirectly. Although the digital asset collateral wallet deposit address may be calculated by the borrower 802 based on knowledge of the public keys generated by the lender 802 and the loan manager 804 in operation 810, a confirming operation 812 may include a request for other parties to agree on the digital asset collateral wallet deposit address since collateral funds will be lost if the deposit address is not correct.

In a depositing operation 814, the borrower 802 deposits digital asset(s) into the digital asset wallet 806. The depositing operation 814 may include a single or multiple transactions broadcast to a blockchain network. The payee of the single or multiple transactions of the depositing operation 814 may be determined from the output of the generating operation 810 based on a combination of the public keys generated therein and/or the confirming operation 812.

A check balance operation 816 by the borrower 802 checks the balance of the digital asset collateral wallet 806 and determines whether a collateral overage condition is satisfied (e.g., based on comparison of the results of the market exchange rate for the digital asset collateral with the digital asset collateral requirements of the loan agreement). In some implementations, the check balance operation 816 includes a request to the loan manager 804 to query market exchange rates for the digital asset available to the loan manager 804. For example, the loan manager 804 may be a party to liquidation agreements with OTC digital asset brokers who may offer a fixed exchange rate for a quantity of the digital asset. The loan manager 804 may make this exchange rate information available to the borrower 802 and/or other participants of the system 800.

If the digital assets in the collateral wallet 806 satisfy the withdrawal condition, the borrower 802 may request transaction signatures from other holders of private keys to the collateral wallet 806. In the case of a 2-of-3 multisig collateral wallet, a borrower 802 requesting signatures must obtain at least one other signature to unlock the wallet 806. The requesting operation 818 may therefore be additionally, or alternatively, directed to the lender. A forming operation 820 forms a transaction to spend from the collateral wallet 806. The forming operation may include signing the transaction, transmitting the signed transaction to the loan manager 804 and/or the lender 802 for signature, and/or broadcasting the signed transaction to the shared ledger network for on-chain confirmation. A receiving operation 822 received digital asset collateral overage from the collateral wallet 806 into a withdrawal address controlled by the borrower 802.

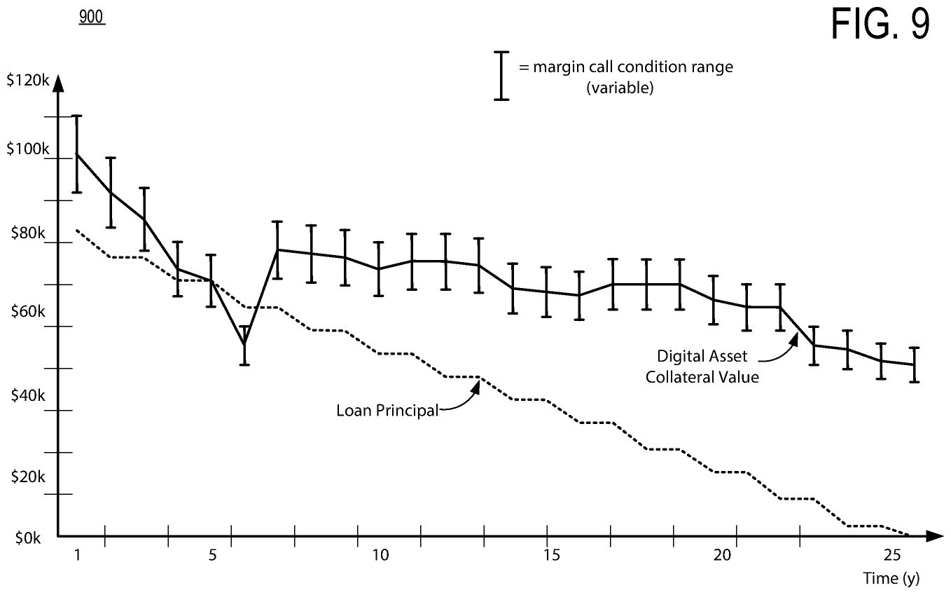

FIG. 9 is a plot 900 of digital asset collateral value and loan principal against time for an example loan case. In the example of plot 900, the digital asset collateral depreciates from the beginning of the loan repayment term. Around year four, the principal balance of the loan comes within the margin call condition band. Entering the margin call condition band could cause components of the system to initiate a margin call warning to the borrower. The margin call condition band may be a variable band, expanding and contracting based on factors determined by the system (e.g., by a loan manager). Factors increasing or decreasing the size of the margin call condition band include available liquidity on digital asset exchanges, exchange offers from OTC private counterparties, expected wait times for blockchain confirmation, expected fees, expected time to receive multisig transaction signatures (e.g., it will take longer to request and receive a transaction from a lender if the lender holds its own private key compared to if the loan manager holds the lender's private key on behalf of the lender).

In the example of plot 900, the borrower adds additional collateral to the multisig wallet after year five to restore the LTV of the loan. Although LTV is not expressly shown on plot 900, it is equal to 100% where the lines cross, is above 100% when the digital asset collateral line is higher than the loan principal line, and below 100% when the digital asset collateral line is lower than the principal line. After the borrower adds additional principal to the collateral wallet, the loan proceeds according to regular payments for the remaining term of the loan repayment period.

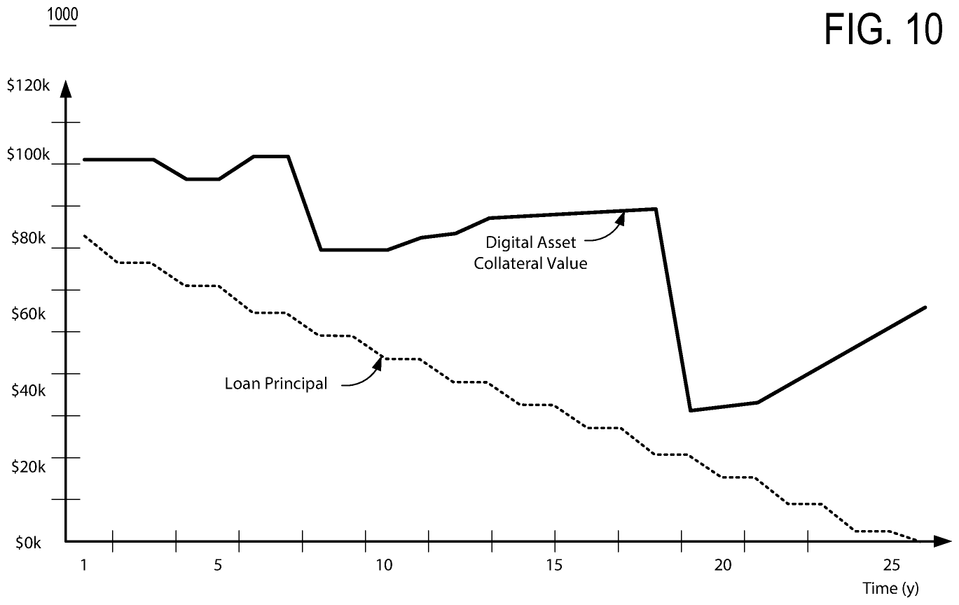

FIG. 10 is a plot 1000 of digital asset collateral value and loan principal against time for an example loan case. In the example of plot 1000, a borrower withdraws digital assets from the digital asset collateral wallet twice in accordance with the collateralization parameters of the loan. After the beginning of the loan period, the digital asset collateral market exchange value remains mostly constant while the principal balance reduces due to regular borrower repayments. As the LTV improves over time due to the repayments, the borrower twice (around years 8 and 19) withdraws an overage quantity of the digital asset collateral while preserving an LTV over 100%.

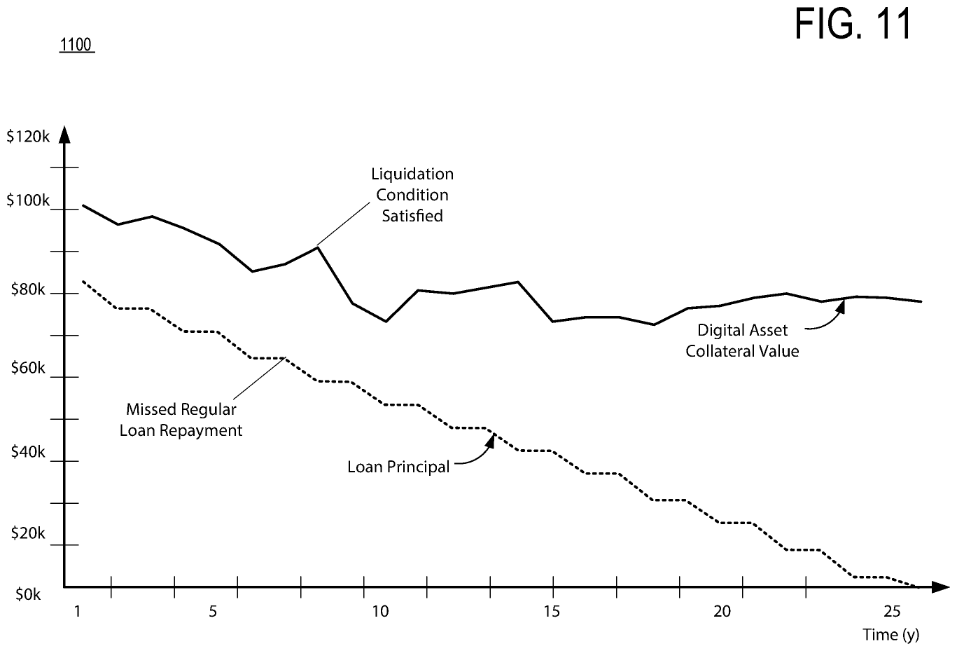

FIG. 11 is a plot 1100 of digital asset collateral value and loan principal against time for an example loan case. In the example of plot 1100, a borrower misses a regular loan repayment on the loan around year six. In this implementation, missing a regular loan repayment satisfies a liquidation condition. The system liquidates a portion of the digital asset collateral in the multisig wallet and applied the proceeds to the principal balance of the loan in accordance with the loan terms. The borrower does not miss additional regular loan repayments, and the loan is completed without liquidating additional digital asset collateral.

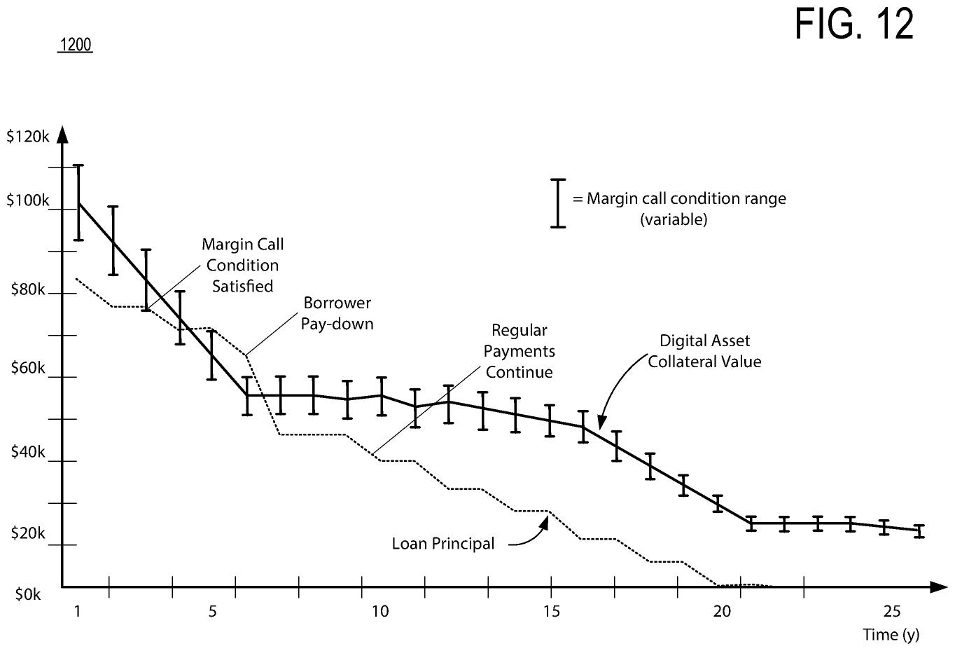

FIG. 12 is a plot 1200 of digital asset collateral value and loan principal against time for an example loan case. In the example of plot 1200, the digital asset collateral value satisfies a margin call condition around year three. In response, a borrower initiates a pay-down of loan principal around year five. The pay-down moves the loan principal amount below the margin call condition band. In the example illustrated in plot 1200, the borrower may skip a number of regularly scheduled payments since the digital asset collateral value maintains exchange rate value and the LTV of the loan satisfies collateral requirement parameters of the loan. Around year nine, regular payments on the loan continue until the loan principal balance is paid off.

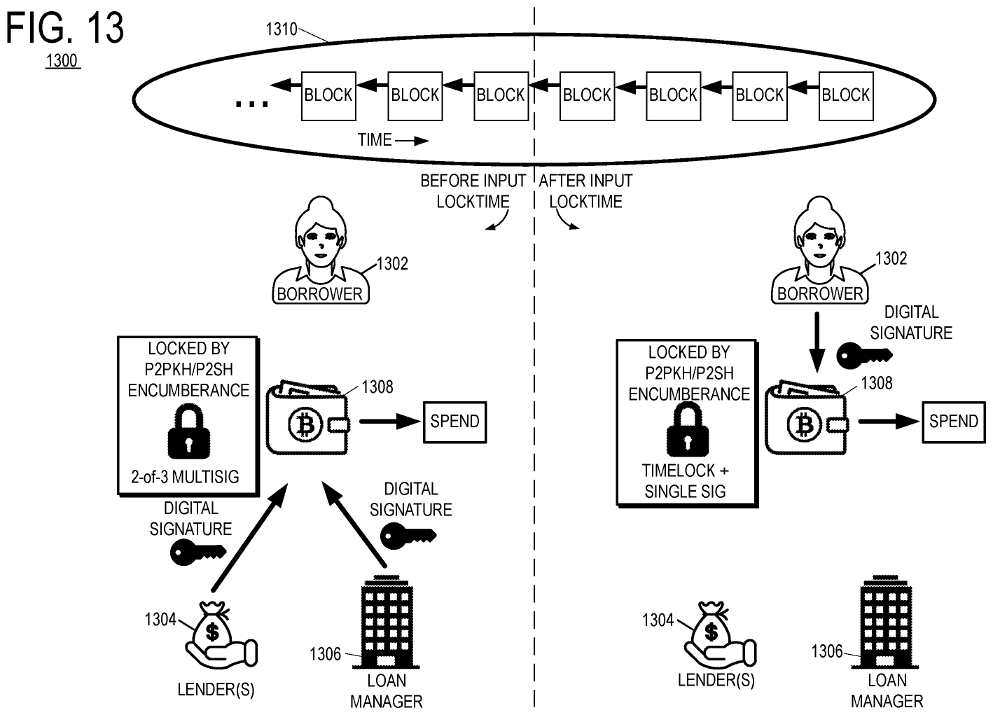

FIG. 13 is a schematic diagram of a system 1300 including a digital asset collateral wallet 1308 locked by encumbrance that depends on a locktime. A locktime dependent encumbrance changes the conditions required to move funds from the digital asset collateral wallet 1308 in a first time period, before the locktime, compared to a second time period, after the locktime, (shown on both sides of the dashed vertical line in FIG. 13). In implementations, the locktime may be based on a block height of the blockchain 1310, or the locktime may be based on clock (e.g., Unix epoch time). A time-dependent encumbrance on the digital asset collateral wallet 1308 protects against potential loss of funds if participants lose their private keys. For example, under a 2-of-3 multisig configuration that is not time-dependent, if both the lender 1304 and the loan manager 1306 lose their private keys, then the digital asset collateral belonging to the borrower 1302 would be lost because it would be stuck in the digital asset collateral wallet 1308 forever. In contrast, a digital asset collateral wallet 1308 that can be unlocked by solely the private key of the borrower 1302 after the loan term has ended will return collateral funds to the borrower 1302 even if all other participants lose their private keys.

The example of FIG. 13 illustrates a digital asset collateral wallet 1308 that requires 2-of-3 multisig's during the loan period and only one digital signature from the borrower after the end of the loan period. The configuration illustrated in FIG. 13 protects both borrower and lender because the lender can still liquidate digital asset collateral if needed at any point during the course of the loan. If the loan term has expired, then either the loan was repaid in full to the lender or the lender liquidated digital asset collateral to satisfy deficiencies in loan repayment. There is therefore no need for the lender to access funds from the digital asset collateral wallet 1308 after expiration of the loan term.

In implementations described herein, the term wallet may refer to one or more outputs of a transaction (e.g., in a blockchain based on a UTXO model) that are “locked” according to a locking script (also known as a witness script). A locking script places certain conditions on the unspent transaction output that must be satisfied to “unlock” or spend the transaction output. The conditions placed on the unspent transaction output may be said to be an encumbrance on the unspent transaction output. The encumbrance may be formulated by the borrower 1302 at the time of depositing the digital asset collateral (P2PKH script) or it may be formulated by another party such as the lender 1304 or loan manager 1306 and a hash thereof provided to the borrower 1302 (P2SH script). Such a locked output may only be spent by a transaction that contains an unlocking script that “solves” or satisfies the conditions placed on the unspent transaction outputs by the locking script. As used herein, the terms “script pub key” may be used to describe a locking script and a “script sig” may be used to describe an unlocking script.

The digital asset collateral wallet represents one or more unspent transaction outputs in the unspent transaction output set of the blockchain 1310. The unspent transaction outputs of the digital asset collateral wallet 1308 are subject to an encumbrance defined by a locking script. In the example illustrated in FIG. 13, the locking script on the digital asset collateral wallet 1308 has two execution paths defined by conditional operators in the script. Each of the two execution paths on the locking script contains a different set of encumbrance parameters that must be satisfied to unlock the funds. A transaction broadcast to the network of the blockchain 1310 seeking to spend the funds in the digital asset collateral wallet 1308 must include an unlocking script that chooses one of the two execution paths in the locking script and supplies an unlocking script that satisfies the execution path chosen by the transaction.

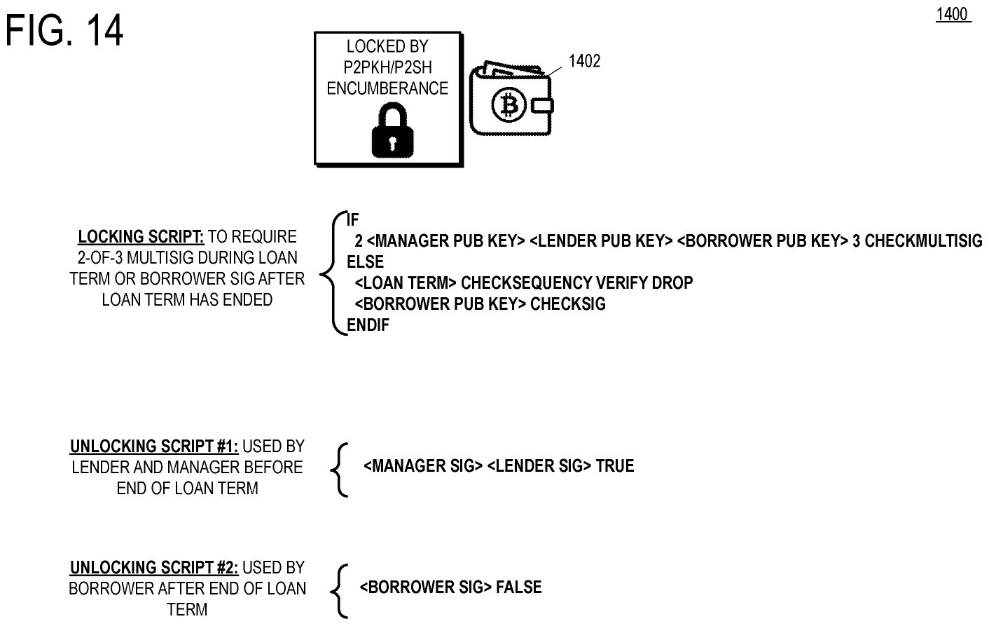

FIG. 14 illustrates a collection of scripts 1400 including an example locking script and example unlocking scripts for a digital asset collateral wallet with a multisig encumbrance. In the example illustrated in FIG. 14, the locking and unlocking scripts are formulated for a consensus mechanism that includes a stack-based LIFO queue for executing operations (e.g., terms are pushed onto the stack, and operators act on one or more terms in their order in the stack). The locking script is an example encumbrance on the unspent outputs represented by the digital asset collateral wallet 1402 that has two execution paths. In other words, in the example of FIG. 14, there are two unlocking scripts that satisfy the locking script to remove the encumbrance and spend the funds held in the digital asset collateral wallet's outputs.

The locking script is in the form of an IF/ELSE/ENDIF block. If execution of the locking script proceeds into the IF block, then the encumbrance is satisfied by 2-of-3 digital signatures of the participants due to the CHECKMULTISIG operator. If execution of the locking script proceeds into the ELSE block, then the encumbrance is satisfied by the borrower's digital signature only if the loan term has expired. In the example of FIG. 14, the operator CHECKSEQUENCEVERIFY is TRUE only if the loan term has expired.

Due to the nature of the LIFO execution stack, elements of the unlocking script are applied to the IF/ELSE/ENDIF block of the locking script from right to left. Example unlocking script #1 includes a TRUE statement, which, when at the top of the execution stack, causes the locking script execution to enter the IF block. Example unlocking script #2 includes a FALSE statement, which, when at the top of the execution stack causes the locking script to enter the ELSE block. In this way, the encumbrance on the digital asset collateral wallet 1402 changes after the end of the loan term.

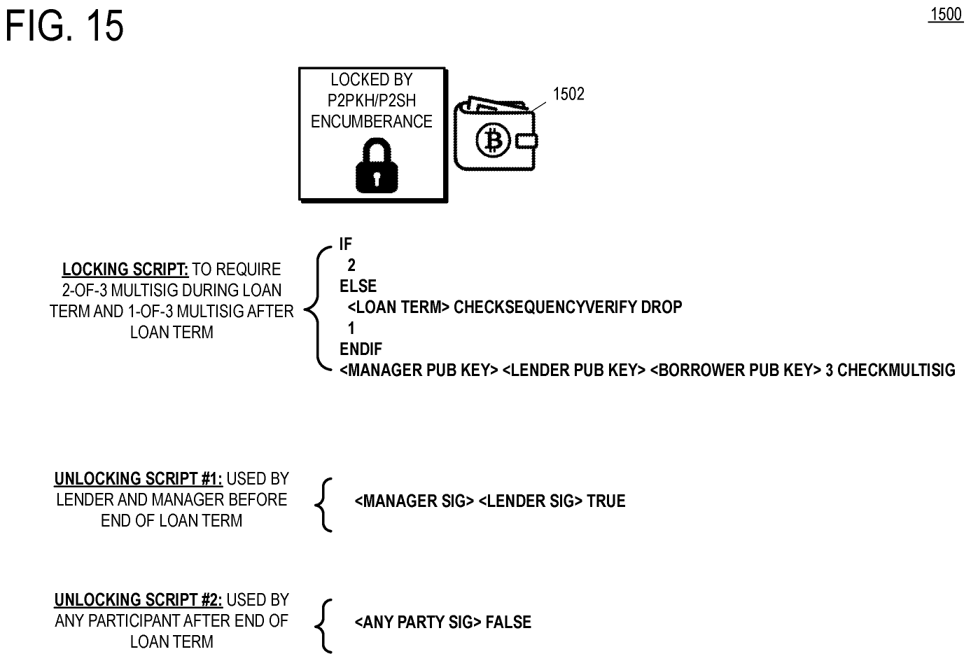

FIG. 15 illustrates another example collection of scripts 1500 including a locking script and two example unlocking scripts for a digital asset collateral wallet 1502 with a multisig encumbrance. Inside the IF block, is a 2. If execution proceeds into the IF block, the 2 is combined with the last line, which constructs a 2-of-3 multisig encumbrance on the wallet 1502. If execution proceeds into the ELSE block, then a 1 is combined with the last line if the loan term has expired (due to the CHECKSEQUENCEVERIFY operator), which constructs a 1-of-3 multisig encumbrance on the wallet 1502. The digital asset collateral wallet 1502 illustrated in FIG. 15 therefore changes from a 2-of-3 to 1-of-3 multisig wallet at the expiration of the loan period. A wallet with this encumbrance may be emptied after the loan repayment period has ended and the digital asset collateral contained therein is due back to the borrower by any of the participants. A borrower may recover the funds herself, or the loan manager or lender may recover the funds and transmit separately to the borrower at the conclusion of the repayment period.

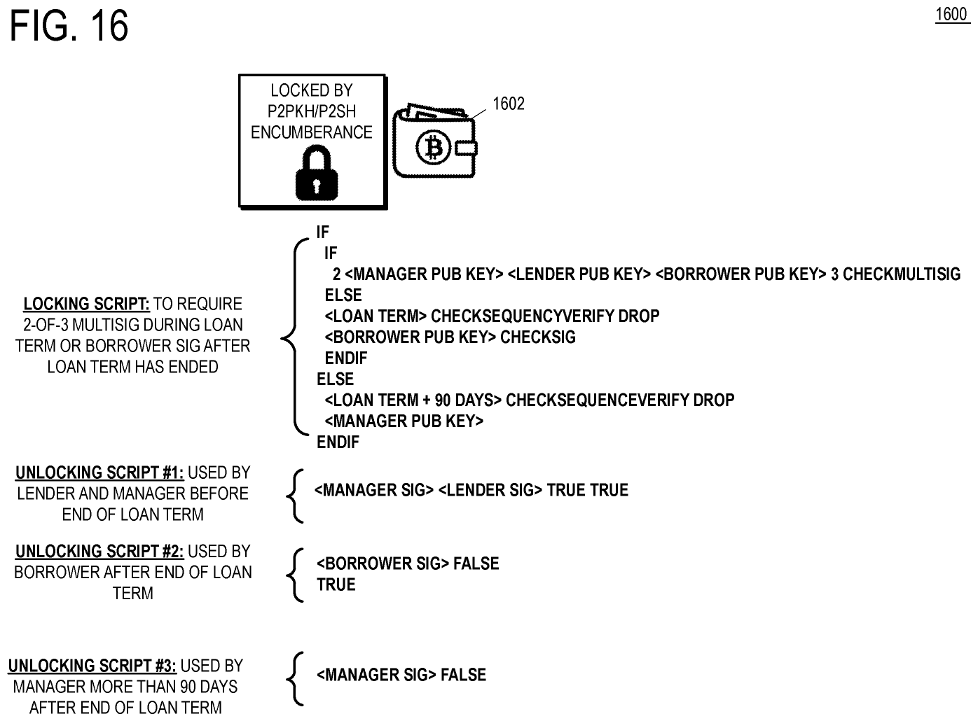

FIG. 16 illustrates another example collection of scripts 1600 including a locking script and three example unlocking scripts for a digital asset collateral wallet 1602. The encumbrance on a digital asset collateral wallet may change at the conclusion of a loan repayment period to allow the borrower to unlock the funds to protect against loss of private key by the loan manager and lender, but the borrower could also lose her private key. To protect against borrower loss of private key, the encumbrance on the digital asset collateral wallet 1602 may change to be unlockable at the end of the loan repayment period by only the borrower, and then change again 90 days after the conclusion of the loan repayment period to allow only the loan manager to recover the funds. Thus, if a borrower loses her private key, the funds can still be recovered by the loan manager and returned to the borrower after the borrower waits 90 days.

The locking script illustrated in FIG. 16 has a nested IF/ELSE/ENDIF structure. Unlocking scripts may choose an execution path through the locking script by including TRUE/FALSE flags at the end of the script. Due to the LIFO nature of the execution stack, terms placed at the “end” of the unlocking script will be processed first by the consensus rules' validators because those terms will have been the last ones pushed onto the stack. If execution proceeds into both IF statements in the locking script, then the wallet 1602 will have a 2-of-3 multisig encumbrance due to the CHECKMULTISIG operator. If execution proceeds into the first ELSE statement of the locking script, the borrower's private key will unlock the wallet but only after expiration of a loan repayment period. If execution proceeds into the second ELSE statement, then the wallet 1602 will be unlockable by the loan manager 90 days after the expiration of the loan repayment period.

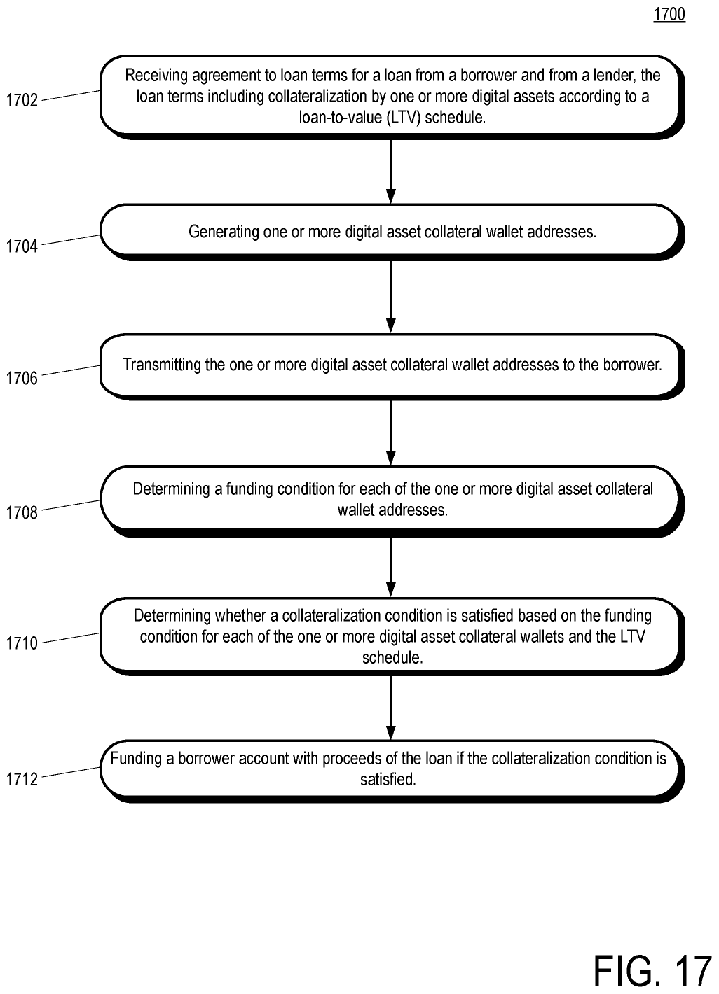

FIG. 17 illustrates example operations 1700 for originating a loan with a digital asset collateral wallet. A receiving operation 1702 receives agreement to loan terms of a loan between a lender and a borrower collateralized by a digital asset associated with a blockchain in a multisig wallet. The loan terms may include one or more LTV schedule(s) for the digital assets of the loan collateral. An LTV schedule may be a set of LTV ranges to determine whether loan operations are permitted including: withdraw excess collateral, send loan warning(s), margin call, and liquidate collateral. The receiving operation 1702 may receive directly from one or both of the lender/borrower. In another implementation, the lender/borrower may store the loan terms and other information regarding the loan such as the repayment schedule in an immutable blockchain (e.g., in a smart contract). The receiving operation 1702 may therefore receive the agreement to loan terms from a copy of the shared blockchain ledger.

A generating operation 1704 generates one or more digital asset collateral wallet addresses. Depending on the collateral, there may be multiple different types of digital assets tracked by more than one blockchain. If so, separate wallets and/or payment addresses may be generated for the blockchains of the respective digital asset collateral. Other types of addresses that could be generated by operation 1704 include a single key or single seed wallet with sharding. Under a sharding scheme, the key needed to spend from a wallet (e.g., a particular private key or a seed/recovery phrase used to deterministically create the wallet keys) is split into more than one location. Techniques such as Shamir's Secret Sharing Scheme (SSSS) may be used to separate and/or unite more than one shard (not necessarily all sharded could be needed) to unlock the wallet.

Another type of wallet address that could be generated by operation 1704 is a smart contract address of a smart contract including executable computer code to carry out functions of the wallet. One of the functions of the wallet could be an n-of-m signing system whereby at least n whitelisted addresses must send data to the smart contract to spend funds held in the contract. The smart contract may include other parameters such as changing spending requirements after a period of the loan repayment has elapsed.

A transmitting operation 1706 transmits the one or more digital asset collateral wallet addresses to the borrower for the borrower to submit collateral thereto. A determining operation 1708 determines a funding condition for each of the one or more digital asset collateral wallet addresses. If the digital asset collateral is held on an utxo-model blockchain, the funding condition may be met by finding that the deposit address exists on a blockchain of the digital asset and that the address, in combination with any other digital asset collateral addresses, has coins associated therewith. If the digital asset collateral is held in a smart contract, the funding condition may be based on being viewable from a copy of the blockchain of the smart contract. The operation that determines the funding condition may include retrieving a market value or exchange rate for the digital assets in the one or more digital asset collateral wallet addresses.

A determining operation 1710 determines whether a collateralization condition is satisfied based on the funding condition for each of the one or more digital asset collateral wallets and the LTV schedule. For example, the LTV may include a minimum LTV to originate the loan, and the collateralization condition is satisfied if the digital asset wallets contain enough digital asset funds such that the LTV of the loan meets the collateralization condition. In other implementations, the determining operation 1710 depends on an expected realized value of the digital asset collateral. The expected realized value may be computer based on a number of factors and can adjust the value of the digital asset collateral from a value based on recent trade prices to one that is based on factors impacting the true amount of funds that could realistically be obtained in the event of a collateral liquidation (e.g., speed from decision to liquidate until sell orders are filled, whether price slippage is expected, expiring OTC offers, etc.).

A funding operation 1712 funds a borrower account with the proceeds of the loan if the collateralization condition is satisfied in operation 1710. The funding operation may include initiating a wire transfer to a bank account of the borrower, approving disbursal of funds from the lender, and/or otherwise originating the loan.

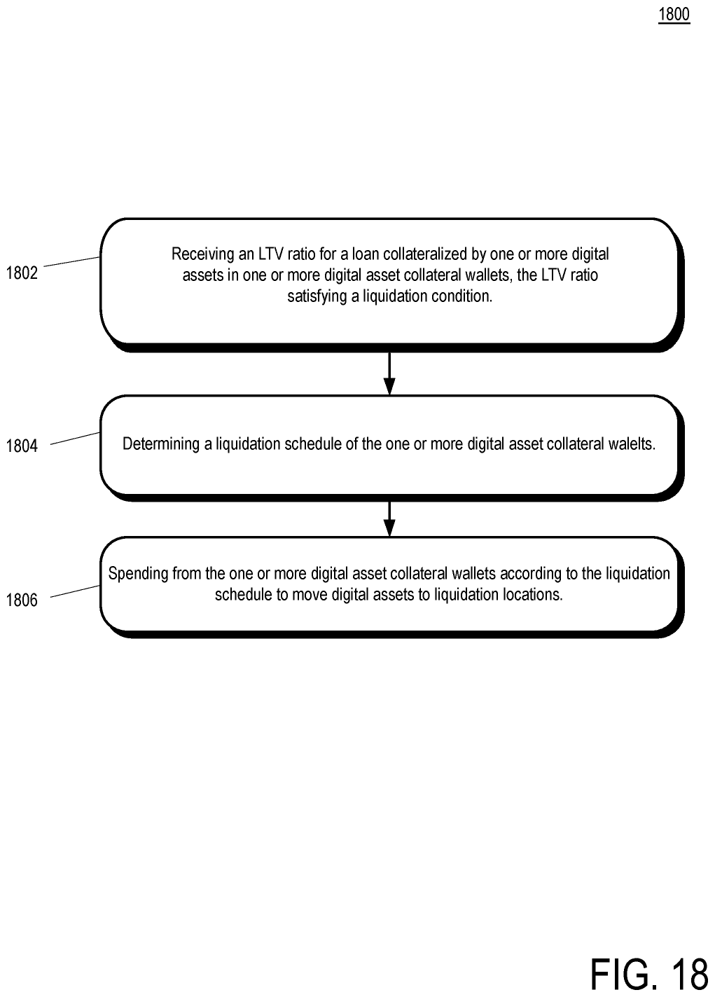

FIG. 18 illustrates example operations 1800 for liquidating digital asset collateral to cure a loan-to-value (LTV) imbalance for a loan. A receiving operation 1802 receives an LTV ratio for a loan collateralized by one or more digital assets in one or more digital asset collateral wallets, the LTV ratio satisfying a liquidation condition. The liquidation condition may be satisfied by comparing a collateral value (or adjusted expected realized value thereof) to an LTV schedule including a liquidation LTV level. The adjusted expected value may be determined based on factors including without limitation: liquidity, trust factor of the digital asset, exchange weighted volume, volatility, amount of digital assets on deposit, OTC offers, etc. If the loan's LTV (or expected realized value) is lower than a liquidation LTV, then the liquidation condition is satisfied.

A determining operation 1804 determines a liquidation schedule of the one or more digital asset collateral wallets. The liquidation schedule may include several components. A first component is an amount of digital assets to liquidate from each type of digital asset held as collateral for the loan. For example, if a loan is collateralized 50% by bitcoin, 30% by ETH, and 20% by Dogecoin, then a liquidation schedule may include maintaining the relative collateralization ratios of the three currencies. In other implementations, other collateral ratios are targeted, and the liquidation funds are obtained by selling more of certain digital assets than others to obtain or get closer to the target ratio. Other aspects of the liquidation schedule may include selling digital assets on deposit at exchanges immediately without waiting for a blockchain transaction to confirm for digital assets in a collateral wallet. Depending on the distribution of available assets on deposit (e.g., a loan manager maintains accounts at three digital asset exchanges with 100 BTC on deposit at each exchange), the liquidation schedule may include selling a portion of the amount to be liquidated on exchanges that have favorable selling conditions (e.g., higher price, less slippage, lower trading fees, etc.). The liquidation schedule may include an expected realized value of the digital assets to be liquidated.

A spending operation 1806 spends from the one or more digital asset collateral wallets according to the liquidation schedule to move digital assets to liquidation conditions. In some implementations, the digital assets liquidated at the liquidation conditions are owned by a loan manager, and the spending operation 1806 only reimburses the loan manager with spent digital assets, thus the spending operation 1806 only indirectly moves digital assets to the liquidation locations.

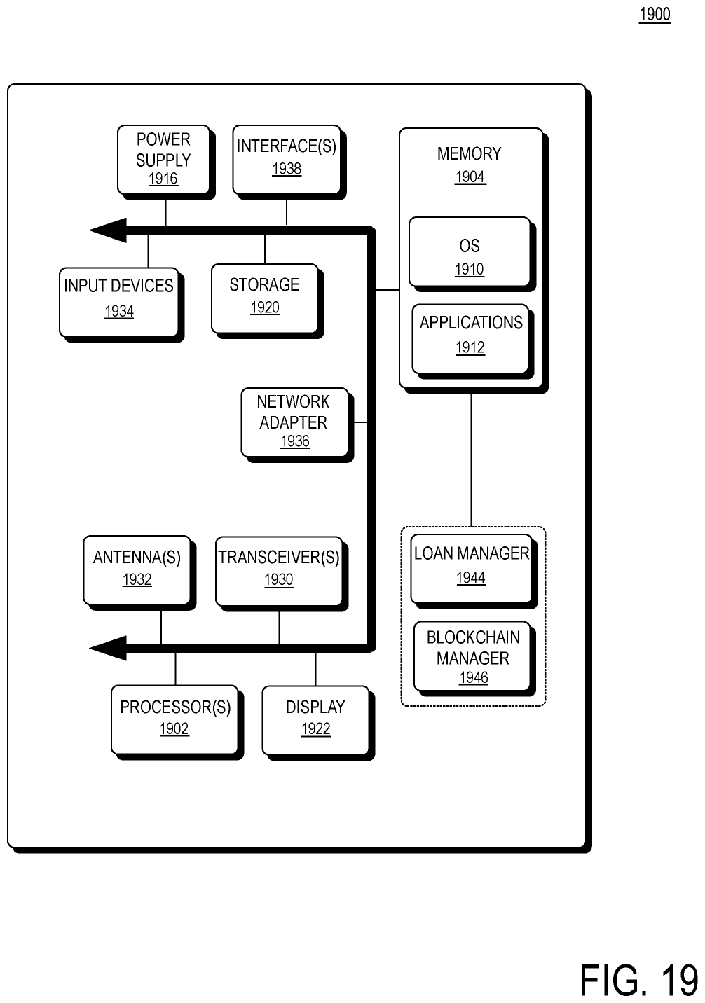

FIG. 19 illustrates an example system 1900 that may be helpful in using the digital asset collateral wallet. FIG. 19 illustrates an example system (labeled as a processing system 1900) that may be useful in implementing the described technology. The processing system 1900 may be a client device, such as a smart device, connected device, Internet of Things (IoT) device, laptop, mobile device, desktop, tablet, or a server/cloud device. The processing system 1900 includes one or more processor(s) 1902, and a memory 1904. The memory 1904 generally includes both volatile memory (e.g., RAM) and non-volatile memory (e.g., flash memory). An operating system 1910 resides in the memory 1904 and is executed by the processor 1902.

One or more application programs 1912 modules or segments, such as loan manager 1944 and blockchain manager 1946 are loaded in the memory 1904 and/or storage 1920 and executed by the processor 1902. Data such as loan terms may be stored in the memory 1904 or storage 1920 and may be retrievable by the processor 1902 for use by loan manager 1944 and the blockchain manager 1946, etc. The storage 1920 may be local to the processing system 1900 or may be remote and communicatively connected to the processing system 1900 and may include another server. The storage 1920 may store resources that are requestable by client devices (not shown). The storage 1920 may include secure storage such as one or more platform configuration registers (PCR) managed by one or more trusted platform modules (TPMs), which may be implanted in a chip or by the trusted execution environment (TEE).

The processing system 1900 includes a power supply 1916, which is powered by one or more batteries or other power sources and which provides power to other components of the processing system 1900. The power supply 1916 may also be connected to an external power source that overrides or recharges the built-in batteries or other power sources.

The processing system 1900 may include one or more communication transceivers 1930 which may be connected to one or more antenna(s) 1932 to provide network connectivity (e.g., mobile phone network, Wi-Fi.®, Bluetooth.®, etc.) to one or more other servers and/or client devices (e.g., mobile devices, desktop computers, or laptop computers). The processing system 1900 may further include a network adapter 1936, which is a type of communication device. The processing system 1900 may use the network adapter 1936 and any other types of communication devices for establishing connections over a wide-area network (WAN) or local area network (LAN). It should be appreciated that the network connections shown are exemplary and that other communications devices and means for establishing a communications link between the processing system 1900 and other devices may be used.

The processing system 1900 may include one or more input devices 1934 such that a user may enter commands and information (e.g., a keyboard or mouse). Input devices 1934 may further include other types of input such as multimodal input, speech input, graffiti input, motion detection, facial recognition, physical fingerprinting, etc. These and other input devices may be coupled to the server by one or more interfaces 1938 such as a serial port interface, parallel port, universal serial bus (USB), etc. The processing system 1900 may further include a display 1922 such as a touch screen display.

The processing system 1900 may include a variety of tangible processor-readable storage media and intangible processor-readable communication signals including virtual and/or cloud computing environments. Tangible processor-readable storage can be embodied by any available media that can be accessed by the processing system 1900 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing system 1900. In contrast to tangible processor-readable storage media, intangible processor-readable communication signals may embody computer-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

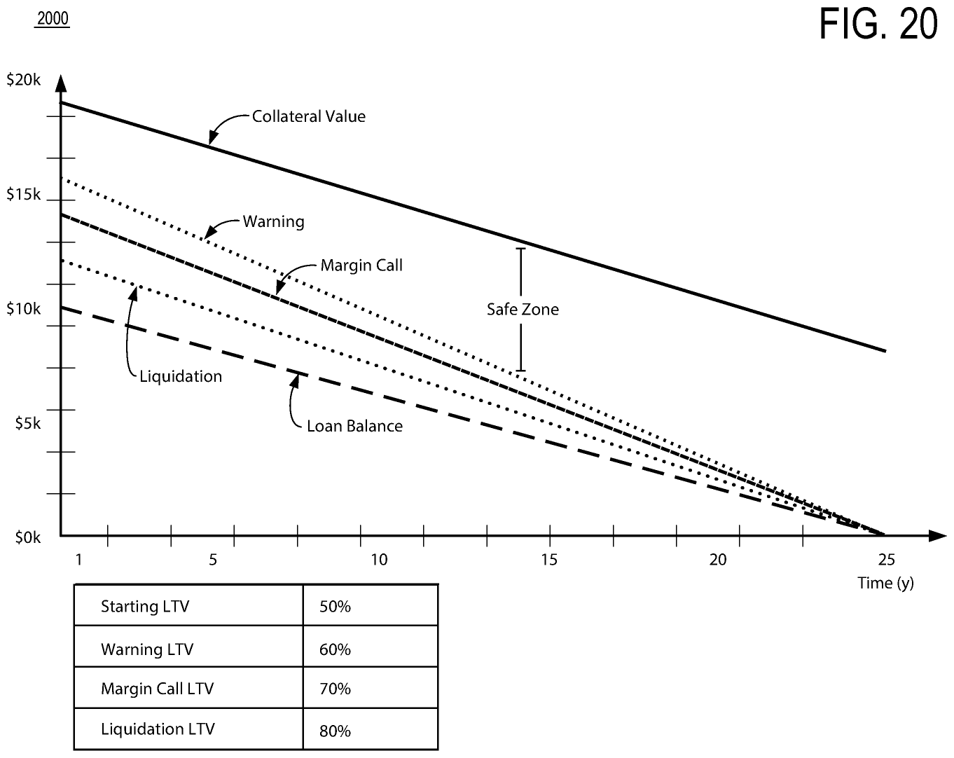

FIG. 20 is an example time plot of a digital asset collateralized loan. An example of an LTV schedule for the loan is shown below the plot with minimum LTV ratios of 50% to originate the loan, 60% to trigger a warning, 70% for a margin call, and 80% for liquidation. In the example illustrated in FIG. 20, the value of the digital asset collateral declines over the period of the loan. The decline could be caused by declining prices of the digital asset collateral and/or by a reduction of collateral such as collateral withdrawn by the borrower. As the loan progresses, the loan balance also declines due to repayments by the borrower. As both lines decline, it can be seen that lines representing the various triggers (warning, margin, and liquidation) also decline because the triggers in this example are defined to be fractions of the LTV ratio. There is thus a “safe zone” for this loan in which the borrower must remain to avoid triggering any of the events in the LTV schedule.

Of course, the applications and benefits of the systems, methods and techniques described herein are not limited to only the above examples. Many other applications and benefits are possible by using the systems, methods, and techniques described herein.

Furthermore, when implemented, any of the methods and techniques described herein, or portions thereof, may be performed by executing software stored in one or more non-transitory, tangible, computer readable storage media or memories such as magnetic disks, laser disks, optical discs, semiconductor memories, biological memories, other memory devices, or other storage media, in a RAM or ROM of a computer or processor, etc.

1-20. (canceled)

21. A system for dynamically managing collateral for a loan on a blockchain, the system comprising:
a loan manager that is representative of a first application program that is executable by the system, the loan manager being configured to:
create a collateral wallet in which to hold one or more digital assets that serve as collateral to secure the loan over an interval of time associated with a first predetermined block height of the blockchain over which the loan is repaid,
define a value for a loan-to-value (LTV) ratio that is representative of a parameter with which the one or more digital assets must comply over the interval of time,
wherein the LTV ratio is dynamically defined based on liquidity of the one or more digital assets, as determined from an analysis of information related to the one or more digital assets, and
lock the collateral wallet in accordance with a locking script that has multiple execution paths,
wherein a first execution path of the multiple execution paths is a multiple-signature encumbrance that requires a quorum of signatures from holders of private keys to the collateral wallet to authorize a transaction before the blockchain reaches the first predetermined block height, and
wherein a second execution path of the multiple execution paths is a single-signature encumbrance that requires a single signature from a holder of a private key to the collateral wallet to authorize a transaction following the blockchain reaching the first predetermined block height;
a loan status aggregator that is representative of a second application program that is executable by the system, the loan status aggregator being configured to receive, on a periodic basis, updates regarding status of the loan;
a loan health monitor that is representative of a third application program that is executable by the system, the loan health monitor being configured to compute, based on the updates, LTV ratios so as to establish whether the one or more digital assets comply with the parameter;
an LTV alarm that is representative of a fourth application program that is executable by the system, the LTV alarm being configured to determine, based on the computed LTV ratios, whether a liquidation condition is satisfied in an ongoing manner; and
a digital asset liquidator that is representative of a fifth application program that is executable by the system, the digital asset liquidator being configured to:
in response to a determination that the liquidation condition is satisfied,
fractionally liquidate the one or more digital assets until the liquidation condition is no longer satisfied.

22. The system of claim 21, wherein the digital asset liquidator is further configured to:
determine at least one placement location for liquidating the one or more digital assets,
create a transaction to accomplish the liquidating and then sign the transaction with one of the private keys to the collateral wallet,
circulate the signed transaction to at least one other party to the loan for signature with at least one more of the private keys, to ensure compliance with the first execution path.

23. The system of claim 22, wherein the first execution path defines a number of private signatures that are needed to commit the signed transaction to the blockchain.

24. The system of claim 21, wherein the loan health monitor is further configured to:
receive input indicative of a request by a borrower to withdraw a portion of the one or more digital assets; and
approve the request in response to a determination that a withdrawal condition is satisfied.

25. The system of claim 21, wherein the digital asset liquidator is further configured to:
apply proceeds from the liquidating to a balance of the loan.

26. The system of claim 21, wherein the loan manager is further configured to:
determine that the blockchain has reached the first predetermined block height, and
release a remaining portion of the one or more digital assets to a borrower by broadcasting a signed transaction to the blockchain, so as to cause a transfer of the remaining portion from the collateral wallet to another wallet associated with the borrower.

27. The system of claim 26, wherein to release the remaining portion, the loan manager unlocks the collateral wallet via the second execution path.

28. The system of claim 21,
wherein the parameter is representative of a minimum LTV value with which the one or more digital assets must comply over the interval of time, and
wherein the loan health monitor is further configured to:
raise the minimum LTV value based on an expected realized value of the one or more digital assets.

29. The system of claim 28, wherein the expected realized value is determined based on (i) a confidence factor in the digital asset, (ii) a global trading volume of the digital asset, or (iii) a trading volume of the digital asset against a currency in which the loan is denominated.

30. The system of claim 21, wherein the digital asset liquidator has access to deposits on multiple exchanges to enable immediate liquidation of the one or more digital assets, as necessary.

31. The system of claim 21, wherein the holder of the private key is a borrower, such that only the borrower is able to unlock the collateral wallet during a first recovery period following the blockchain reaching the first predetermined block height.

32. The system of claim 31,
wherein the collateral wallet has a third execution path in addition to the first and second execution paths,
wherein the third execution path is a multiple-signature encumbrance that requires a single signature using a private key associated with a lender, and
wherein the collateral wallet is unlockable via the third execution path during a second recovery period that begins after the first recovery period expires, such that the collateral wallet is unlockable only by the lender after the first recovery period expires.

33. The system of claim 21, wherein multiple digital assets serve as collateral to secure the loan over the interval of time.

34. The system of claim 33, wherein the loan manager is further configured to:
define a weighted LTV schedule by assigning a separate weight to each of the multiple digital assets.

35. A system for dynamically managing collateral for a loan between a lender and a borrower on a blockchain, the system comprising:
a processor;
a blockchain participant that operates as a full node in a network of the blockchain, the blockchain participant being configured to access a ledger representing a transaction history on the blockchain;
a communications interface at which to periodically receive status updates for the loan; and
a first application program that, when executed by the processor, is configured to:
create a collateral wallet in which to hold a digital asset that serves as the collateral for the loan,
wherein the collateral wallet is associated with a public key for which the lender and the borrower hold private keys, so as to allow the loan to be managed without requiring an identity of the borrower be revealed to the lender;
define a metric that is representative of a parameter with which the digital asset must continually comply over an interval of time associated with a first predetermined block height of the blockchain, and
lock the collateral wallet in accordance with a locking script that has multiple execution paths,
wherein the multiple execution paths include (i) a first execution path that is implemented before the blockchain reaches the first predetermined block height and (ii) a second execution path that is implemented following the blockchain reaching the first predetermined block height;
a second application program that, when executed by the processor, is configured to compute values for the metric based on the status updates received at the communications interface; and
a third application program that, when executed by the processor, is configured to determine whether to fractionally liquidate the digital asset based on whether the computed values satisfy a liquidation condition.

36. The system of claim 35, further comprising:
a fourth application program that, when executed by the processor, is configured to:
alert a party to the loan via electronic communication in response to a determination that one of the computed values satisfies the liquidation condition.

37. The system of claim 35, wherein the metric is based on liquidity of the digital asset as determined from an analysis of information related to the digital asset that is received at the communications interface.

38. The system of claim 37, wherein the information specifies global trading volume, trading volume against a currency in which the loan is denominated, depth of order books, estimated slippage, over-the-counter (OTC) trading availability, or any combination thereof.

39. The system of claim 35, further comprising:
a fourth application program that, when executed by the processor, is configured to:
in response to the third application program determining that one of the computed values satisfies the liquidation condition,
fractionally liquidate the digital asset until the liquidation condition is no longer satisfied.

40. The system of claim 39,
wherein the digital asset is one of multiple types of digital assets that serve as the collateral to secure the loan, and
wherein the first application is further configured to:
define a weighted schedule for computing the metric by assigning a separate weight to each of the multiple types of digital assets.
